(19) United States
(12) Patent Application Publication
(10) Pub. No.: US 2007/0048181 A1
(43) Pub. Date: Mar. 1, 2007

(54) Carbon dioxide nanosensor, and respiratory CO2 monitors

(76) Inventors: Daniel M. Chang, Danville, CA (US); Ying-Lan Chang, Cupertino, CA (US); Jean-Christophe P. Gabriel, Pinole, CA (US); Vikram Joshi, Newington, CT (US); William Mickelson, San Francisco, CA (US); Joseph Niemann, Fremont, CA (US); John Loren Passmore, Berkeley, CA (US); Alexander Star, Pittsburgh, PA (US); Christian Valcke, Orinda, CA (US)

Correspondence Address: O'MELVENY & MYERS LLP, 610 NEWPORT CENTER DRIVE, 17TH FLOOR, NEWPORT BEACH, CA, 92660, US

(21) Appl. No.: 11/488,456

(22) Filed: Jul. 18, 2006

Related U.S. Application Data
(63) Continuation-in-part of application No. 10/656,898, filed on Sep. 5, 2003.
(63) Continuation-in-part of application No. 10/940,324, filed on Sep. 13, 2004.
(63) Continuation-in-part of application No. 11/019,792, filed on Dec. 20, 2004.
(63) Continuation-in-part of application No. 11/111,121, filed on Apr. 20, 2005.
(63) Continuation-in-part of application No. 11/390,493, filed on Mar. 27, 2006.
(63) Continuation-in-part of application No. 11/437,275, filed on May 18, 2006.
(60) Provisional application No. 60/408,547, filed on Sep. 5, 2002.
(60) Provisional application No. 60/502,485, filed on Sep. 12, 2003.
(60) Provisional application No. 60/531,079, filed on Dec. 18, 2003.
(60) Provisional application No. 60/564,248, filed on Apr. 20, 2004.
(60) Provisional application No. 60/665,153, filed on Mar. 25, 2005.
(60) Provisional application No. 60/683,460, filed on May 19, 2005.
(60) Provisional application No. 60/700,944, filed on Jul. 20, 2005.
(60) Provisional application No. 60/730,905, filed on Oct. 27, 2005.
(60) Provisional application No. 60/773,138, filed on Feb. 13, 2006.

(51) Int. Cl. G01N 31/22

(52) U.S. Cl. 422/57

(57) ABSTRACT

An electronic system and method for detecting analytes, such as carbon dioxide, is provided, using an improved nanostructure sensor (CO2 sensor). The CO2 sensor may comprise a substrate and a nanostructure, such as a one or more carbon nanotubes disposed over the substrate (e.g., as a network). One or more conductive elements may electrically communicate with the nanostructure. A counter or gate electrode may be positioned adjacent the nanostructure. A functionalization material reactive with carbon dioxide may be included, either disposed in contact with the nanostructure or isolated by a dielectric. The sensor may be connected to a circuit responsive to changes in CO2 concentration in the environment. Embodiments are described of medical sensing systems including one or more CO2 sensors. One embodiment comprises a breath sampling cannula which is connected to a sensor unit. In an alternative, the cannula permits supplemental oxygen to be administered, while recovering and measuring analytes in breath samples. The cannula may connect to a portable processor-display unit for monitoring one or more analytes, such as CO2. Another embodiment includes a cannula configured for the monitoring of sleep disorders, such as apnea, comprising one or more sensors disposed adjacent a breath sampling channel, optionally including flow rate or other sensors. The sensors may be connected by wired or wireless links for to a processor/input/display unit. Any of the embodiments may include filters, selectively permeable membranes, absorbents, and the like to precondition the breath sample, may be configured to include complementary chemistry measurements.

### CROSS-REFERENCE TO RELATED APPLICATIONS

This application is a continuation-in-part of and claims priority to U.S. patent application Ser. No. 10/656,898 filed Sep. 5, 2003 entitled “Polymer Recognition Layers For Nanostructure Sensor Devices” (published US 2005-0279,987), which in turn claims priority to Provisional Application No. 60/408,547 filed Sep. 5, 2002.

This application is a continuation-in-part of and claims priority to U.S. patent application Ser. No. 10/940,324 filed Sep. 13, 2004 entitled “Carbon Dioxide Nanoelectronic Sensor” (published US 2005-0129,573), which in turn claims priority to U.S. Provisional Patent Application No. 60/502,485 filed Sep. 12, 2003.

This application is a continuation-in-part of and claims priority to U.S. patent application Ser. No. 11/019,792 filed Dec. 18, 2004 entitled “Nanoelectronic capnometer adapter” (published US 2005-0245,836); which in turn claims priority to U.S. Provisional Patent Application No. 60/531,079, filed Dec. 18, 2003.

This application is a continuation-in-part of and claims priority to U.S. patent application Ser. No. 11/111,121 filed Apr. 20, 2005 entitled “Remotely communicating, battery-powered nanostructure sensor devices” (published US 2006-0055,392); which in claims priority to U.S. Provisional Patent Application No. 60/564,248, filed Apr. 20, 2004.

This application is a continuation-in-part of and claims priority to U.S. patent application No. 11/390,493 filed Mar. 27, 2006 entitled “Nanoelectronic Measurement System For Physiologic Gases, And Improved Nanosensor For Carbon Dioxide”; which in claims priority to U.S. Provisional Patent Application No. 60/665,153 filed Mar. 25, 2005.

This application is a continuation-in-part of and claims priority to U.S. patent application Ser. No. 11/437,275 filed May 18, 2006 entitled “Nanoelectronic Breath Analyzer and Asthma Monitor”; which in turn claims priority to U.S. Provisional Patent Application No. 60/683,460, filed May 19, 2005.

This application claims priority to U.S. Provisional Application No. 60/700,944 filed Jul. 20, 2005, entitled “Portable Medical Analysis System Including An Integrated CO2-Sensing Cannula”; to U.S. Provisional Application No. 60/730,905 filed Oct. 27, 2005, entitled “Nanoelectronic Sensors And Analyzer System For Monitoring Anesthesia Agents And Carbon Dioxide In Breath”; and to U.S. Provisional Application No. 60/773,138, filed Feb. 13, 2006 entitled “Nanoelectronic Capacitance Sensors For Monitoring Analytes”.

Each of the above identified patent applications are specifically incorporated herein, in their entirety, by this reference.

### BACKGROUND

1. Field of the Invention

The present invention relates to nanoelectronic devices, and nanostructured sensor systems for measurement of inorganic, organic and biological analytes. In particular, the invention relates to medically relevant analytes such as carbon dioxide. The present invention also relates to embodiments of apparatus for patient medical monitoring including sensing analytes of exhaled breath.

2. Description of Related Art

Currently, state-of-the-art sensing of CO₂ in indoor air quality applications makes use of relatively large, power-hungry infrared sensors. Size, cost, and power constraints result in only limited use of these sensors. If smaller, lower power, and lower cost CO₂ sensors could be made, they could be used much more widely. For example, in building air management, greater use of CO₂ sensors could result in better control of heating and ventilation systems, and thus energy cost savings. Other exemplary potential applications for simple, disposable CO₂ sensors may include medical applications such as capnography, wherein carbon dioxide levels in respiration are measured during intensive care and anesthesia. The high cost and limitations of current CO₂ sensors restrict the use of capnography to high value, controlled environments, such as surgical wards. Inexpensive, disposable CO₂ sensors would not only reduce capnography costs, but would facilitate mobile and temporary monitoring and broaden the reach of the technology. Accordingly, there is a need for a smaller, lower power, and lower cost CO₂ sensor for a variety of applications.

The measurement of carbon dioxide levels in respiration is a standard procedure during intensive care and anesthesia and is a primary tool in the diagnosis and management of respiratory function. A need in this medical monitoring is to measure and track CO₂ concentration in the breath, sometimes referred to as capnography. To meet the necessary specifications of such capnography device, current technology relies on bulky and expensive non-dispersive infrared absorption (NDIR) sensors to determine CO₂ concentration. The high cost and limitations of this technology restrict the use of capnography to high value, controlled environments, such as surgical wards. In addition, it has been shown that capnography is particularly important in determining the proper placement of endotracheal tubes in emergency medical response.

In addition it is desirable to perform measurement of CO₂ and/or other analytes in exhaled breath in an integrated medical procedure, such as the with the administration of supplemental oxygen by a oxygen emitting nasal cannula. the administration of treatment substances in air mixture or suspension, or the detection and monitoring of sleep disorders, such as apnea.

### SUMMARY OF THE INVENTION

Certain examples of nanoelectronic sensors employing nanostructures are described in parent application Ser. No. 10/940,324 (published US 2005-0129,573), which is incorporated by reference. The present application improved nanostructure sensing devices (nanoelectronic sensor or nanosensor) having aspects of the invention for the measurement of analytes, in particular CO₂. Embodiments of nanoelectronic sensors comprise a substrate and a nanostructure disposed over the substrate. As used herein, the term “nanostructure” includes a particulate or macromolecular entity having at least one dimension less than about 100 nm.

In an embodiment of the invention, the nanostructure comprises one or more single-wall carbon nanotubes (SWNTs), e.g., a network or mesh of SWNTs. Alternative nanostructures include multiple-wall carbon nanotubes, nanowires, nanofibers, nanorods, nanospheres, or the like, or mixtures of these. Although the principal examples include one or more carbon nanotubes, the nanostructures may may comprise boron, boron nitride, and carbon boron nitride, silicon, germanium, gallium nitride, zinc oxide, indium phosphide, molybdenum disulphide, silver, or other suitable materials.

One or more conductive elements are disposed adjacent the nanostructure and communicate electrically connected to the nanostructure. The CO₂ sensor may be connected to an electrical circuit, which will respond to changes in CO₂ concentration in the ambient sensor environment.

In a number of examples, a functionalization material reactive with carbon dioxide is disposed on CO₂ sensor, for example, on the nanotube. Recognition layers that preserve the semi-conductive or conductive properties may be selected from noncovalent materials, for example, polymer coatings. In certain examples, a recognition material may be isolated from the nanostructure by an insulating coating, such as an ALD dialectic material. Accelerators and/or catalysts may be included in a recognition layer to improve sensor response to an analyte.

Gate electrodes, reference electrodes or other counter electrodes may be included, e.g., for transistor measurements or capacitance measurements of sensor properties. Carbon nanotube field-effect transistor devices (NTFETs) may be fabricated which exhibit device characteristics that respond to chemical analytes through charge transfer between the NTFET and the analytes. Specific sensitivity can be achieved by employing recognition layers that induce chemical reactions with a targeted analyte, thereby measurably changing the NTFET device characteristics.

Particular examples of medical systems having aspects of the invention are described, employing nanosensors for measuring CO₂ so as to overcome limitations of the prior art. Such novel nanoelectronic systems offer: (i) performance that matches or exceeds that of infrared technology, (ii) plug-and-play simplicity in a disposable package, (iii) the small size and low power consumption needed for wireless integration and (iv) the ability to incorporate arrays of sensors on a single chip or substrate. This CO₂ sensing technology offers an order of magnitude reduction in the cost of the sensor component.

Medical applications for such novel nanoelectronic systems include:
a. Anesthesia—to monitor adequacy of ventilation, verification of proper intubation and quality of respiration during surgical procedures, and during post-op and intensive care.
b. Emergency medical services—end tidal CO₂ is a predictor of cardiac output and an indicator of adequate respiration related to endotracheal tube placement, cardiac arrest or respiratory arrest, trauma, seizures, shock, diabetic ketoacidosis, asthma, and the like.
c. Procedural sedation in clinical settings—to provide monitoring of respiration during sedation in non-hospital treatment at a level of care equivalent to hospital practice.
d. Asthma monitoring—to assess the severity of a bronchospasm and success of medication or treatment.
e. Sleep Apnea—monitoring of CO₂ levels to screen for apnea, the stoppage of breathing, and the efficacy of therapeutic machines.
f. Metabolic Testing—tracking expired CO₂ levels and volumes to assess metabolic rate.
g. Gastro-Intestinal Testing—to monitor breath CO₂ as part of testing for such conditions as lactose/fructose intolerance, bacterial overgrowth, H. Pylori (peptic ulcers), and the like.

CO₂ sensors having aspects of the invention can be included in embodiments for breath monitoring for emergency medicine, for example, airway adapters, masks, ambubags, and laryngeal masks etc. The construction of the sensor assembly is flexible to address most airway monitoring environments. Among the applications where the capnometers having aspects of the invention could provide significant healthcare benefits are: Endotracheal Tube Verification; Breathing Quality Assessment; Intra and Inter-Hospital Transport; Adequacy of CPR.

One embodiment comprises a breath sampling cannula which is connected to a sensor unit, which is preferably disposable. The breath sampling cannula permits supplemental oxygen (O₂) to be administered to a patient for inhalation, while recovering samples of the patient's oral and nasal exhaled breath. The sensor unit may in turn be connected to a portable processor/input/display unit which permits real-time measurement and monitoring of a patients exhaled breath for one or more analytes, such as carbon dioxide (CO₂).

An alternative embodiment includes an integrated CO₂ sensing, O₂ delivery cannula, comprising one or more sensors disposed adjacent one or more exhaled breath sampling channels, so as to detect and monitor one or more medical analytes in the exhaled breath (e.g., CO₂). The sensing cannula is preferably disposable. The sensing cannula may be connected (e.g., wired or wireless) for communicating a sensor signal to a processor/input/display unit.

An alternative embodiment includes an integrated CO₂ sensing cannula configured for convenient use by a sleeping or bed resting patient, comprising one or more sensors disposed adjacent one or more exhaled breath sampling channels, so as to detect and monitor one or more medical analytes in the exhaled breath (e.g., CO₂, NO and the like), for example in the monitoring of sleep disorders or airway inflammation.

Any of the described embodiments may include filters, selectively permeable membranes, absorbents, and the like to precondition the breath sample prior to sensor contact, and the processor/input/display may be configured to include other complementary chemistry measurements, such as pulse oximetry and the like.

One exemplary embodiment of a nanostructure sensor for sensing carbon dioxide having aspects of the inventions comprises a substrate; a first nanostructure disposed adjacent the substrate; one or more conducting elements in electrical communication with the first nanostructure; and at least one recognition material operatively associated with the first nanostructure, the at least one recognition material configured for interacting with carbon dioxide. In another embodiment, the recognition material includes an aqueous solution, such as water, that is capable of reacting with carbon dioxide.

The recognition material may be direct contact with the nanostructure or may be isolated from the nanostructure by a dielectric layer. Such dielectric layer may be less than about 500 nm thick, preferably between about 50 nm and about 1 nm and more preferably between about 30 nm and 5 nm thick. A dielectric layer may be deposited by atomic layer deposition (ALD). One exemplary embodiment of a nanostructure sensor further includes at least a second layer deposited by ALD having material properties distinct from the dielectric layer. The second layer includes a recognition material configured for interacting with carbon dioxide.

In certain embodiments, the recognition material includes an aqueous solution, such as water, capable of absorbing or dissolving carbon dioxide. The recognition material may comprise an accelerator configured to catalyze the conversion of aqueous carbon dioxide to carbonic acid. The accelerator may include carbonic anhydrase, and/or an analogous catalyst.

An embodiment of a medical system having aspects of the invention comprises: a breath sampling cannula including one or more lumens configured to by mounted adjacent at least one of a patient's nostril and mouth, the lumen having an opening arranged to gather an exhaled breath sample upon patient exhalation; one or more nanostructure sensor comprised described above, the sensor in communication with the lumen of the breath sampling cannula, so as to contact at least a portion of the exhaled breath sample; a processing unit in communication with the sensor so as to receive the sensor signal, the processor unit configured to use the signal to determine a measurement of one of: (i) the concentration of CO₂ in the sample; and (ii) the amount of CO₂ in the sample, and an output device in communication with the processing unit and configured to output at least the measurement to a user, so as to provide information related to a human medical state. An alternative embodiment of a medical system having aspects of the invention comprises: one or more first sensors comprised as described above having a sensitivity for carbon dioxide; at least one second sensor having a sensitivity for at least one second non-carbon-dioxide species found in human exhaled breath, and wherein the concentration of carbon dioxide and the second species in human exhaled breath has a correlation with a human medical state; a breath sampler configured to sample at least the exhaled breath of a patient, and in communication with the first and second sensors; a processor system in communication with the first and second sensors and configured to measure the concentration of carbon dioxide and the second species, and to the measurements to a user, so as to provide information related to the human medical state.

A more complete understanding of CO₂ sensors and systems incorporating CO₂ sensors having aspects will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

The following are summary descriptions of the Figures, provided for convenience, and further reference is made to the full description of each herein:

FIG. 1 s a schematic diagram showing an exemplary nanostructure sensor for use with the invention.

FIG. 2 is a plot showing the response of an exemplary nano-electronic carbon dioxide sensor to a range of low concentrations of carbon dioxide in air.

FIG. 3 is a plot showing the response of an exemplary nano-electronic carbon dioxide sensor to a wide range concentrations of carbon dioxide in air.

FIG. 4 is a plot showing the response of an exemplary capnometer having aspects of the invention to simulated human breathing.

FIG. 5 schematically illustrates an electronic system having aspects of the invention for detecting carbon dioxide.

FIG. 6 shows an example of a nanosensor having an electrical isolation layer (e.g. formed by ALD) coating a nanostructure channel.

FIG. 7 shows an example of a nanosensor having a composite recognition structure including a selectively permeable layer and a CO₂ reactive layer (e.g. formed by ALD) coating a nanostructure channel.

FIGS. 8 and 9 schematically illustrates an exemplary embodiments of “packaged” sensor devices having aspects of the invention, adapted to measure CO₂.

FIGS. 10A to 10G are schematic diagrams showing various examples of respiratory airway or capnometer sensor adaptor mountings having aspects of the invention, wherein:

FIG. 10A1 to 10A2 are frontal and side elevation views respectively of a wired capnometer sensor and adapter system;

FIG. 10B is a schematic diagram showing a wireless capnometer sensor and adapter system from an end view relative to the tube fitting.

FIG. 10C is a schematic diagram showing a wired capnometer sensor and adapter system with all electronics remote from the sensor, from an end view relative to the tube fitting.

FIG. 10D is a schematic diagram showing a capnometer sensor and adaptor with remote electronics, wherein the sensor is disposed directly in the airstream of the adaptor fitting.

FIG. 10E is a schematic showing an exemplary alternative structure for an adaptor and sensor of the type shown in FIG. 4, wherein the sensor is disposed in the airstream.

FIG. 10F is a schematic diagram showing a side view of a capnometer sensor and adapter generally similar to that shown in FIGS. 1A and 1B, but having a sensor arranged adjacent a secondary parallel lumen in communication with the airway passage.

FIG. 10G is a schematic diagram showing a side view of a capnometer sensor and adapter generally similar to that shown in FIG. 6, but having inlet and outlet ends of the secondary parallel lumen projecting into airway passage into the exhalation flow path.

FIGS. 11A, 11B and 11C depict exemplary configurations of a capnometer adaptor, in which the output device is mounted to the adapter housing and displays a quantitative bar graph.

FIG. 12 depicts an exemplary configuration of a capnometer adaptor, in which the output device is mounted to the adapter housing and displays a both a digital reading and a quantitative bar graph.

FIGS. 13A and 13B depict exemplary configurations of a capnometer adaptor, in which either one or both of the sensor and the electronic circuitry is separately detachable from the airway adaptor housing.

FIG. 14 is a diagrammatic depiction of an exemplary configuration of a portable medical gas sensing system comprising a breath sampling cannula connected to a supplemental oxygen (O₂) source and connected to a sensor unit, in turn connected to a portable processor/input/display unit.

FIG. 15 is a perspective drawing which depicts the breath sampling cannula included in FIG. 14.

FIG. 16 is a diagrammatic depiction of an alternative configuration of a portable medical gas sensing system comprising an integrated CO₂ sensing, O₂ delivery cannula, shown connected to a processor/input/display unit.

FIG. 17A and 17B are a cross-section and top view respectively of the integrated CO₂ sensing, O₂ delivery cannula, included in FIG. 16.

FIGS. 18 A, B, and C show an alternative embodiment of an integrated sensing cannula

FIGS. 19 A, B, and C show an exemplary embodiment of an integrated sensing cannula configured to produce signals for input to a processor unit to analyze a patients breathing function to diagnose and monitor sleep disorders, such as sleep apnea and the like.

### DETAILED DESCRIPTION OF PREFERRED EMBODIMENTS

### Nanosensor Architecture

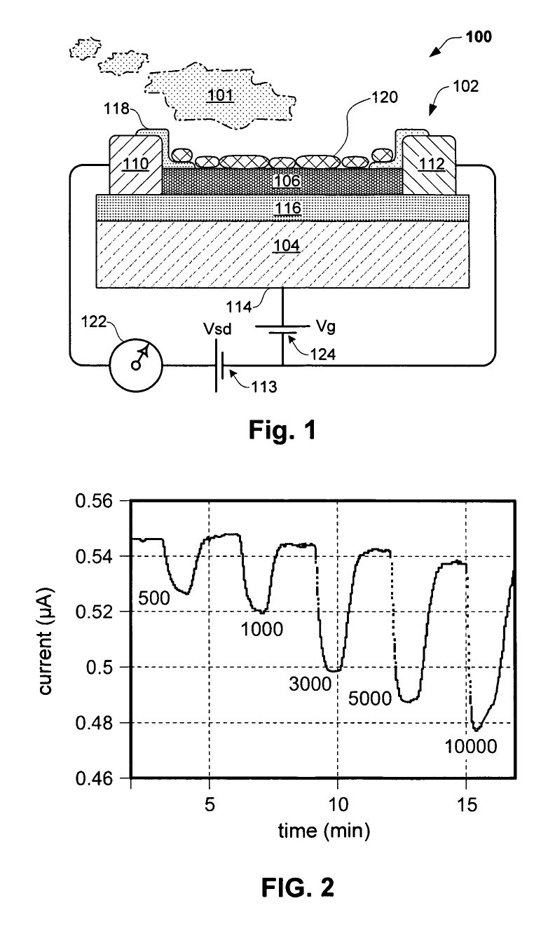

FIG. 1. shows an exemplary electronic sensing device 100 having aspects of the invention, for detecting an analyte 101 (e.g. CO₂, H₂ or NO, and the like), comprising a nanostructure sensor 102. Sensor 102 comprises a substrate 104, and a conducting (e.g., semiconducting) channel or layer 106 comprising a nanostructure material, such as a nanotube or network of nanotubes, disposed on the substrate. The nanostructure material 106 may contact the substrate as shown, or in the alternative, may be spaced a distance away from the substrate, with or without a layer of intervening material.

In an embodiment of the invention, conducting channel 106 may comprise one or more carbon nanotubes. For example, conducting channel 106 may comprise a plurality of nanotubes forming a mesh, film or network. Certain exemplary embodiments having aspects of the invention include nanostructure elements which may be made using chemical vapor deposition (CVD) and traditional lithography, or may be deposited by other methods, such as solvent suspension deposition, AFM manipulation, and the like. Certain embodiments include one or more discrete nanotubes in electrical contact with one or more metal electrodes. A number of different arrangements of active nanostructures may be included without departing from the spirit of the invention.

One or more conductive elements or contacts 110, 112 may be disposed over the substrate and electrically connected to conducting channel 106 comprising a nanostructure material. Elements 110, 112 may comprise metal electrodes in contact with conducting channel 106. In the alternative, a conductive or semi-conducting material (not shown) may be interposed between contacts 110, 112 and conducting channel 106. Contacts 110, 112 may comprise source and drain electrodes, respectively, upon application of a source-drain voltage V_{sd}. The voltage or polarity of source 110 relative to drain 112 may be variable, e.g., the applied voltage may be DC, AC, pulsed, or variable. In an embodiment of the invention, the applied voltage is a DC voltage.

In the example of FIG. 1, the device 100 may be operated as a gate-controlled field effect transistor, with sensor 102 further comprising a gate electrode 114. Such a device is referred to herein as a nanotube field effect transistor or NTFET. Gate 114 may comprise a base portion of substrate 104, such as a doped-silicon wafer material isolated from contacts 110, 112 and channel 106 by a dielectric layer 116, so as to permit a capacitance to be created by an applied gate voltage V_{g}. For example, the substrate 104 may comprise a silicon back gate 114, isolated by a dielectric layer 116 comprising SiO₂. Alternatively gate 114 may include a separate counter electrode, liquid gate or the like.

Sensor 102 may further comprise a layer of inhibiting or passivation material 118 covering regions adjacent to the connections between the conductive elements 110, 112 and conducting channel 106. The inhibiting material may be impermeable to at least one chemical species, such as to the analyte 101 or to environmental materials such as water or other solvents, oxygen, nitrogen, and the like. The inhibiting material 118 may comprise a passivation material as known in the art, such as silicon dioxide, aluminum oxide, silicon nitride, or other suitable material. Further details concerning the use of inhibiting materials in a NTFET are described in prior co-invented U.S. Pat. No. 6,894,359 entitled “Sensitivity Control For Nanotube Sensors” which is incorporated by reference herein.

The conducting channel 106 (e.g., a carbon nanotube layer) may be functionalized to produce a sensitivity to one or more target analytes 101. Although nanostructures such as carbon nanotubes may respond to a target analyte through charge transfer or other interaction between the device and the analyte, more generally a specific sensitivity can be achieved by employing a recognition material 120, also called a functionalization material, that induces a measurable change in the device characteristics upon interaction with a target analyte.

Device 100 may further comprise suitable circuitry in communication with sensor elements to perform electrical measurements. For example, a conventional power source may supply a source drain voltage V_{sd} (113) between contacts 110, 112. Measurements via the sensor device 100 may be carried out by circuitry represented schematically by meter 122 connected between contacts 110, 112. In embodiments including a gate electrode 114, a conventional power source 124 may be connected to provide a selected or controllable gate voltage V_{g}. Device 100 may include one or more electrical supplies and/or a signal control and processing unit (not shown) as known in the art, in communication with the sensor 102.

Optionally, device 100 may comprise a plurality of sensors like sensor 102 disposed in a pattern or array, such as described in prior application Ser. No. 10/388,701 filed Mar. 14, 2003 entitled “Modification Of Selectivity For Sensing For Nanostructure Device Arrays” (now published as US 2003-0175161), which is incorporated by reference herein. Each device in the array may be functionalized with identical or different functionalization. Identical device in an array can be useful in order to multiplex the measurement to improve the signal/noise ratio or increase the robustness of the device by making redundancy. Different functionalization may be useful for providing sensitivity to a greater variety of analytes with a single device.

Substrate. The substrate 104 may be insulating, or on the alternative, may comprise a layered structure, having a base 114 and a separate dielectric layer 116 disposed to isolate the contacts 110, 112 and channel 106 from the substrate base 114. The substrate 104 may comprise a rigid or flexible material, which may be conducting, semiconducting or dielectric. Substrate 104 may comprise a monolithic structure, or a multilayer or other composite structure having constituents of different properties and compositions. Suitable substrate materials may include quartz, alumina, polycrystalline silicon, III-V semiconductor compounds, and the like. Substrate materials may be selected to have particular useful properties, such as transparency, microporosity, magnetic properties, monocrystalline properties, polycrystalline or amorphous properties, or various combinations of these and other desired properties. For example, in an embodiment of the invention, the substrate 104 may comprise a silicon wafer doped so as to function as a back gate electrode 114. The wafer being coated with intermediate diffusion barrier of Si₃N₄ and an upper dielectric layer of SiO₂. Optionally, additional electronic elements may be integrated into the substrate for various purposes, such as thermistors, heating elements, integrated circuit elements or other elements.

Optionally, the substrate may include protective and surface conditioning layers. For example a diffusion barrier may be included to prevent contamination of a substrate, such as doped silicon, by metallic catalysts or other substances introduced during fabrication steps. See U.S. patent application Ser. No. 11/111,121 filed Apr. 20, 2005 entitled “Remotely communicating, battery-powered nanostructure sensor devices”; both of which applications are incorporated by reference.

In certain alternative embodiments, the substrate may comprise a flexible insulating polymer, optionally having an underlying gate conductor (such as a flexible conductive polymer composition), as described in application Ser. No. 10/846,072 filed May 14, 2004 entitled “Flexible Nanotube Transistors”, the entirety of which application is incorporated herein by this reference. In further alternative embodiments, the substrate may comprise a polymeric substance coated with nanotube or other nanostructure particles in the in the manner described in U.S. application Ser. No. 11/274,747 filed Nov. 14, 2005 entitiled “Nanoelectronic Glucose Sensors”, which application is incorporated by reference.

Contacts or electrodes. The one or more conductor or contacts 110, 112 used for the source and drain electrodes can be any of the conventional metals used in semiconductor industry, or may be selected from Au, Pd, Pt, Cr, Ni, ITO, W or other metallic material or alloy or mixture thereof. For example, electrical leads may be patterned on top of a nanotube network channel from titanium films 30 nm thick capped with a gold layer 120 nm thick. In the alternative, other conductive materials may be employed, such as conductive polymers and the like. The dimension of the distance between source 110 and drain 112 may be selected to achieve desired characteristics for a particular application. It should be understood that one or more of each of a source and drain electrode may be arranged in an interdigitated or spaced-apart electrode array, permitting a comparative large area of nanostructure channel 106 having a comparatively small source-drain gap to be arranged compactly.

Gate electrode 114 may comprise materials generally similar to contacts 110, 112. In the alternative, the gate electrode 114 may comprise a sublayer within substrate 104. Gate electrode 114 may comprise doped silicon, patterned metal, ITO, other conductive metal or non-metal material, or combinations thereof. Alternative forms of gate electrodes may be employed, such as a top gate, a gate effected via a conducting analyte carrier medium (e.g. an aqueous solution). Optionally, a device 102 may comprise such other electrodes as a counter electrode, a reference electrode, a pseudo-reference electrode, without departing from the spirit of the invention.

Nanostructure or nanostructure layer. Exemplary embodiments having aspects of the invention include sensor devices having at least one conducting channel 106 comprising one or more nanostructures. As used herein, the term “nanotructure” includes a particulate or macromolecular entity having at least one dimension less than about 100 nm. For example, the nanostructures of conducting channel or layer 106 may comprise one or more single-wall carbon nanotubes, multiple-wall carbon nanotubes, nanowires, nanofibers, nanorods, nanospheres, or the like. Although the principal examples include one or more carbon nanotubes, the nanostructures may may comprise boron, boron nitride, and carbon boron nitride, silicon, germanium, gallium nitride, zinc oxide, indium phosphide, molybdenum disulphide, silver, or any other suitable material.

In an embodiment of the invention, conducting channel or nanostructure layer 106 comprises an interconnected network of smaller nanostructures disposed to form a percolation layer, mesh, or film which provides at least one electrical conduction path between a source electrode 110 and a drain electrode 112. In such a network of nanoparticles, it is not necessary that any single nanoparticle extends entirely between the source and drain contacts. In operation the conductivity of channel 106 between source electrode 110 and drain electrode 112 may be maintained by interconnections, contacts or communications between adjacent nanostructures. In an embodiment of the invention, nanostructure conducting channel 106 comprises one or more single-walled or multi-walled carbon nanotubes. Preferably, the density of a network or film of nanostructure particles may be adjusted so that the network is close to, or a selected margin above, the percolation limit (minimum density for conductivity along a given direction, such as between two contact points). Note that where the network or film comprises a mixture of nanostructures or particles of non-uniform conductivity (e.g., mixture of metallic and semiconducting nanotubes), and where generally the individual nanostructure particles are of a length substantially less than the contact separation, the conductivity of a network is a statistical property (e.g. metallic nanotubes do not “short” the network). Where highly elongate particles (such as carbon nanotubes) are included, the spacing of contacts and/or characteristic particle length may be adjusted to a desired ratio of these lengths. Note that useful nanostructure networks may alternatively be formed from nanostructure particles which are not characteristically elongate. A useful network of nanotubes may be provided, for example, by distributing a dispersion of single wall carbon nanotubes (SWNTs) over a substrate so as to be approximately planar and randomly oriented. Preferably, a substantial portion of the nanotubes have semiconducting properties.

Nanoparticle Network Formation. Nanostructure networks may be formed by various suitable methods. One suitable approach may comprise forming an interconnecting network of single-wall carbon nanotubes directly upon the substrate, such as by reacting vapors in the presence of a catalyst or growth promoter disposed upon the substrate. For example, single-walled nanotube networks can be grown on silicon or other substrates by chemical vapor deposition from iron-containing catalyst nanoparticles with methane/hydrogen gas mixture at about 900 degrees C. Advantageously, the use of highly dispersed catalyst or growth-promoter for nanostructures permits a network of nanotubes of controlled diameter and wall structure to be formed in a substantially random and unclumped orientation with respect to one another, distributed substantially evenly at a selected mean density over a selected portion of the substrate. The particle size distribution may be selected to promote the growth of particular nanotube characteristics, such as tube diameter, number of walls (single or multi-walled), conductivity, or other characteristics. Other catalyst materials and gas mixtures can be used to grow nanotubes on substrates, and other electrode materials and nanostructure configurations and are disclosed in application Ser. No. 10/099,664, filed Mar. 15, 2002 entitled “Modification Of Selectivity For Sensing For Nanostructure Sensing Device Arrays”, and in International Application No. PCT/US03/19,808, filed Jun. 20, 2003, entitled “Dispersed Growth Of Nanotubes On A Substrate” and published as WO2004-040,67 1, both of which applications are incorporated by reference.

In an alternative, conducting layer 106 comprising an interconnecting network of nanostructures may be formed by deposition from a solution or suspension of nanostructures, such as a solution of dispersed carbon nanotubes. See for example, the methods described in U.S. patent application Ser. No. 10/846,072, filed May 14, 2004 entitled “Flexible Nanotube Transistors”, which is incorporated by reference. Such methods as spin coating, spray deposition, dip coating and ink-jet printing may be employed to deposit the solution or suspension of nanostructures such as SWNTs, in the manner described in U.S. application Ser. No. 11/274,747 filed Nov. 14, 2005 entitled “Nanoelectronic Glucose Sensors”, which application is incorporated by reference.

Functionalization or Recognition Layer. The sensor functionalization material 120 may be selected for a specific application, such as to interact with a targeted analyte 101 to cause a measurable change in electrical properties of nanosensor device 102. For example, the functionalization material 120 may cause an electron transfer to occur in the presence of analyte 101, or may influence local environment properties, such as pH and the like, so as to indirectly change device characteristics. Alternatively or additionally, the recognition material may induce electrically-measurable mechanical stresses or shape changes in the nanostructure channel 106 upon interaction with a target analyte. Sensitivity to an analyte or to multiple analytes may be provided or regulated by the association of a nanotube conducting channel 106 with an adjacent functionalization material 120. Specific examples of suitable functionalization materials are provided later in the specification. The functionalization material 120 may be disposed as a continuous or discontinuous layer on or adjacent to channel 106.

Functionalization material 120 may be selected for a wide range of alternative chemical or biomolecular analytes. Examples include functionalization specific to gas analytes of industrial or medical importance, such as carbon dioxide as disclosed in application Ser. No. 10/940,324 filed Sep. 13, 2004 entitled “Carbon Dioxide Nanoelectronic Sensor”, which is incorporated herein by reference. See also application Ser. No. 10/656,898 referenced hereinabove. Functionalization material 120 may comprise as little as a single compound, element, or molecule bonded to or adjacent to the nanostructure channel 106. In addition, or in the alternative, functionalization materials may comprise a mixture or multilayer assembly, or a complex species (e.g., including both synthetic components and naturally occurring biomaterials).

Materials in the functionalization layer may be deposited on the NTFET using various different methods, depending on the material to be deposited. For example, inorganic materials, such as sodium carbonate, may be deposited by drop casting from 1 mM solution in light alcohols. The functionalized sensor may then be dried by blowing with nitrogen or other suitable drying agent. Polymeric materials may be deposited by dip coating. A typical procedure may involve soaking of the chip with the carbon nanotube device in 10% polymeric solution in water for 24 hours, rinsing with water several times, and blowing the chip dry with nitrogen. Polymers which are not soluble in aqueous solutions may be spin coated on the chip from their solutions in organic solvents. Values of polymer concentrations and the spin coater's rotation speeds may be optimized for each polymer. Further details pertaining to polymer recognition layers may be described in commonly-owned application Ser. No. 10/658,898, filed Sep. 5, 2003, which is also incorporated by reference herein.

Measurement Systems. The electronic circuitry described herein is by way of illustration, and a wide range of alternative measurement circuits may be employed without departing from the spirit of the invention. Embodiments of an electronic sensor device having aspects of the invention may include an electrical circuit configured to measure one or more properties of the nanosensor 120, such as measuring an electrical property via the conducting elements 110, 112. For example, a transistor sensor may be controllably scanned through a selected range of gate voltages, the voltages compared to corresponding measured sensor current flow (generally referred to herein as an I-V_{g} curve or scan). Such an I-V_{g} scan may be through any selected gate voltage range and at one or more selected source-drain potentials. The V_{g} range is typically selected from at least device “on” voltage through at least the device “off” voltage. The scan can be either with increasing V_{g}, decreasing V_{g}, or both, and may be cycled positive or negative at any selected frequency.

In addition to the transconductance/NTFET example of FIG. 1, it should be understood that alternative embodiments of an electronic sensing device for detecting an analyte having aspects of the invention may include sensors configured with other architectures and for measurement of other properties. Any suitable electrical or magnetic property may provide the basis for sensor sensitivity, for example, electrical resistance, electrical conductance, current, voltage, capacitance, impedance, inductance, transistor on current, transistor off current, and/or transistor threshold voltage. In the alternative, or in addition, sensitivity may be based on a measurements including a combination of properties, relationships between different properties, or the variation of one or more properties over time. For example, a sensor embodiment may include circuitry and elements configured and optimized for measurement of capacitance relative to a nanostructured sensor element, for example, the response of the capacitance of a functionalized nanotube network to interaction with an analyte of interest.

Note that a sensor system may include suitable circuitry to perform measurement of more than one property of a single electronic sensor device. For example, a sensor device configured as a FET may have (a) resistance or conductance measurements performed across the conductive channel element, (b) channel resistance or conductance may be measured under the influence of constant or variable gate voltage, (c) a capacitance or impedance of the device measured relative to the gate electrode (or other counter electrode) and the conductive channel, (d) time integrated characteristics such as hysterisis, phase shifts, recovery behavior, or like properties or combinations thereof. The use of multiple measurement strategies using a single sensor on a real-time basis allows increased accuracy, sensitivity and selectivity.

From such measurements, and from derived properties such as hysteresis, time constants, phase shifts, or scan rate/frequency dependence, correlations may be determined with target detection or concentration. The electronic sensor device may include or be coupled with a suitable microprocessor or other computer device as known in the art, which may be suitably programmed to carry out the measurement methods and analyze the resultant signals. Those skilled in the art will appreciate that other electrical or magnetic properties may also be measured as a basis for sensitivity. Accordingly, the embodiments disclosed herein are not meant to restrict the types of device properties that can be measured.

Optionally, the measurement circuitry may be configured so as to provide compensation for such factors as temperature and pressure and humidity. See U.S. patent application Ser. No. 11/111,121 filed Apr. 20, 2005 entitled “Remotely communicating, battery-powered nanostructure sensor devices”; both of which applications are incorporated by reference.

### CO₂ Sensor Example

In an exemplary embodiment of a carbon dioxide (CO₂) sensor (see schematic of FIG. 1), sensitivity to CO₂ may be achieved using a suitable functionalization material or layer 120 (which may be continuous or discontinuous). The functionalization layer may perform two main functions: 1) to selectively recognize carbon dioxide molecules and 2) upon the binding of CO₂ to generate an amplified signal that is transferred to the carbon nanotube transducer. In the presence of water, carbon dioxide forms carbonic acid which dissociates and alters the pH of the functionalization layer, thus protonating the electron donating groups and making the NTFET more p-type. Basic inorganic compounds (e.g., sodium carbonate), pH-sensitive polymers, such as polyaniline, poly(ethyleneimine), poly(o-phenylenediamine), poly(3-methylthiophene), and polypyrrole, as well as aromatic compounds (benzylamine, naphthalenemethylamine, antracene amine, pyrene amine, etc.) may be used to functionalize NTFETs for CO₂ sensing. The functionalization layer may be constructed using polymeric materials such as polyethylene glycol, poly(vinyl alcohol) and polysaccharides, including various starches as well as their components amylose and amylopectin.

Functionalization material 120 may comprise more than one material and/or more than one layer of material, also referred to as “functionalization material”, “functionalization layer” or “functionalization”. The functionalization layer has two main functions: 1) it selectively recognizes carbon dioxide molecules and 2) upon the binding of CO₂ it generates an amplified signal that is transferred to the nanostructure (e.g., carbon nanotube) transducer. Basic inorganic compounds (e.g., sodium carbonate), pH-sensitive polymers, such as polyaniline, poly(ethyleneimine), poly(o-phenylenediamine), poly(3-methylthiophene), and polypyrrole, as well as aromatic compounds (benzylamine, naphthalenemethylamine, anthracene amine, pyrene amine, etc.) can be used to functionalize NTFETs for CO₂ sensing. The functionalization layer can be constructed using certain polymeric materials such as polyethylene glycol, poly(vinyl alcohol) and polysaccharides, including various starches as well as their components amylose and amylopectin. For example, a suitable reaction layer may be formed from a combination of PEI or similar polymer with a starch polymer. Other suitable materials for the functionalization layer may include, for example, metals, metal oxides, and metal hydroxides. In addition, a metallic functionalization layer may be combined with a polymeric functionalization layer.

Materials in the functionalization layer may be deposited on the NTFET using various different methods, depending on the material to be deposited. For example, inorganic materials, such as sodium carbonate, may be deposited by drop casting from 1 mM solution in light alcohols. The functionalized sensor may then be dried by blowing with nitrogen or other suitable drying agent. Polymeric materials may be deposited by dip coating. A typical procedure may involve soaking of the chip with the carbon nanotube device in 10% polymeric solution in water for 24 hours, rinsing with water several times, and blowing the chip dry with nitrogen. Polymers which are not soluble in aqueous solutions may be spin coated on the chip from their solutions in organic solvents. Values of polymer concentrations and the spin coater's rotation speeds may be optimized for each polymer.

In one exemplary embodiment having aspects of the invention, the functionalization layer 815 includes PAMAM or poly(amidoamine) dendrimer, which has a branched structure suitable for formation of hydrogels. PAMAM is available commercially in a number of types and forms, such as from Dendritic NanoTechnologies, Inc.; Dendritech, Inc; and Sigma-Aldrich Co. For example, an ethylenediamine core may have poly(amidoamine) branches with terminal amine groups. See Xu-Ye Wu, Shi-Wen Huang, Jian-Tao Zhang, Ren-Xi Zhuo, “Preparation and Characterization of Novel Physically Cross-linked Hydrogels Composed of Poly(vinyl alcohol) and Amine-Terminated Polyamidoamine Dendrimer”, Macromol. Biosci. 2004, 4, 71-75, which is incorporated by reference.

Functionalization material 120 may be comprised so as to balance hydrophobicity, hydrophilicity and basic properties (e.g., amino polymers), so as to optimize response time and cross-sensitivity to other species in the sample environment, such as relative humidity. The use of thin film coatings or assembled monolayers (SAM) can be employed to improve response time.

Alternative materials for layer 120 may include, for example, those shown in TABLE 1. Such materials may be included in sensors such as are describe herein without departing from the spirit of the invention.

TABLE 1
Examples of alternative recognition materials

| | |
|---|---|
| V₂O₅ | WO₃ |
| Polyacrylic acid | Polyurethane resin |
| Poly(acrylic acid-co-isooctylacrylate) | Polycarbazole |
| poly(ethylene imine), “PEI” | poly(sulfone) |
| poly(4-vinylphenol) | poly(vinyl acetate) |
| poly(alkyl methacrylate) | poly(vinyl alcohol) |
| poly(a-methylstyrene) | poly(vinyl butyral) |
| poly(caprolactone) | polyacrylamide |
| poly(carbonate bisphenol A) | polyacrylonitrile |
| poly(dimethylsiloxane) | polyaniline |
| poly(ethylene glycol) | polybutadiene |
| poly(ethylene oxide) | polycarbonate |
| poly(ethylenimine) | polyethylene |
| poly(methyl vinyl ether-co-maleic | polyoxyethylene |
| anhydride) | |
| poly(N-vinylpyrrolidone) | polypyrrole |
| poly(propylene) | polytetrafluoroethylene |
| poly(styrene) | polythiophene |
| polyvinyl-methyl-amine | Polyvinyl pyridine |
| polyaminostyrene | |
| chitosan | chitosan HCL |
| polyallylamine | polyallylamine HCL |
| poly(diallylamine) | poly(diallylamine) HCL |
| poly(entylene-co-vinyl acetate), ˜82% | poly-(m-aminobenzene |
| ethylene | sulfonic acid), “PABS” |
| poly(styrene-co-allyl alcohol), ˜5.7% | poly(vinyl chloride-co- |
| hydroxyl | vinyl acetate), ˜10% |
| | vinyl acetate |
| poly(styrene-co-maleic anhydride), ˜50% | poly(vinylidene chloride- |
| styrene | co-acrylonitrile), ˜80% |
| | vinylidene chloride |

Materials in the functionalization layer may be deposited on the NTFET using various different methods, depending on the material to be deposited. For example, inorganic materials, such as sodium carbonate, may be deposited by drop casting from 1 mM solution in light alcohols. The functionalized sensor may then be dried by blowing with nitrogen or other suitable drying agent. Polymeric materials may be deposited by dip coating. A typical procedure may involve soaking of the chip with the carbon nanotube device in 10% polymeric solution in water for 24 hours, rinsing with water several times, and blowing the chip dry with nitrogen. Polymers which are not soluble in aqueous solutions may be spin coated on the chip from their solutions in organic solvents. Values of polymer concentrations and the spin coater's rotation speeds may be optimized for each polymer.

FIG. 2 is a plot showing the response of an exemplary nano-electronic carbon dioxide sensor having aspects of the invention to a low range of concentrations of carbon dioxide in air. The sensor shows wide dynamic range in the concentration range of 500 to 10,000 ppm. Suitable recognition chemistry and specificity permit the sensor to operate at different relative humidities and shows low cross-sensitivity to anesthesia gases (oxygen and nitrous oxide).

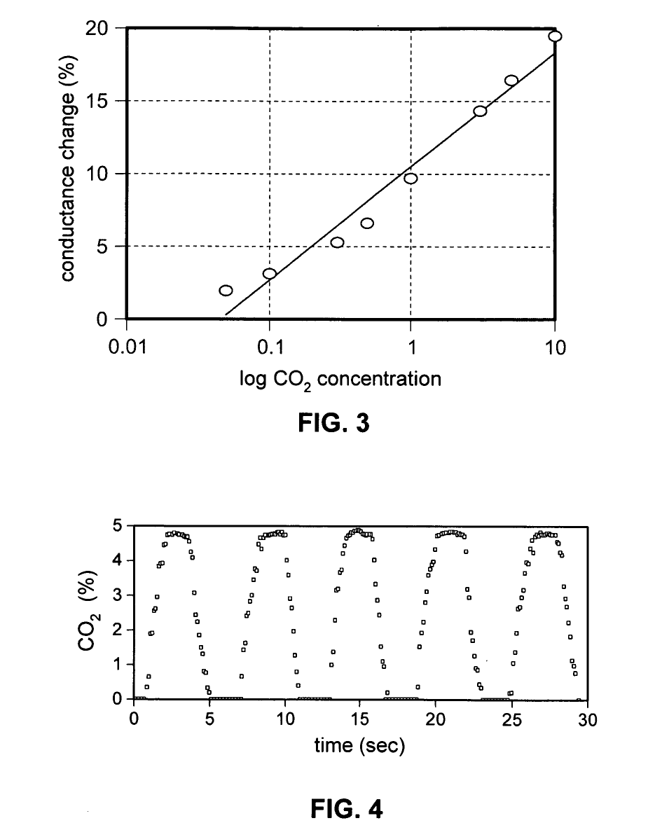

FIG. 3 is a plot showing the response of an exemplary nano-electronic carbon dioxide sensor having aspects of the invention to a wide and high range of concentrations of carbon dioxide in air, ranging from 500 to 100,000 ppm (0.5%-10%). The sensor shows a wide dynamic range and the response to CO₂ gas is fast and reproducible at different concentrations. Suitable recognition chemistry and specificity permit the sensor to operate at different relative humidities and shows low cross-sensitivity to anesthesia gases (oxygen and nitrous oxide).

FIG. 4 is a capnogram plot showing the response of an exemplary capnometer having aspects of the invention to simulated human breathing. The performance of the sensor at this clinically relevant condition shows the great potential for these sensors in capnography and anesthesia medical applications. Capnometers having aspect of the invention may be included in many different sorts of medically useful system, both as permanent, semi-disposable, or completely disposable components. Likewise, a variety of different arrangements of the sensors, signal and power circuitry and data display and recordation subsystems are practical.

Further aspects of a nanosensor for sensing carbon dioxide are disclosed in application Ser. No. 10/940,324 filed Sep. 13, 2004 (published US 2005-0129,573), which is incorporated herein, in its entirety, by reference.

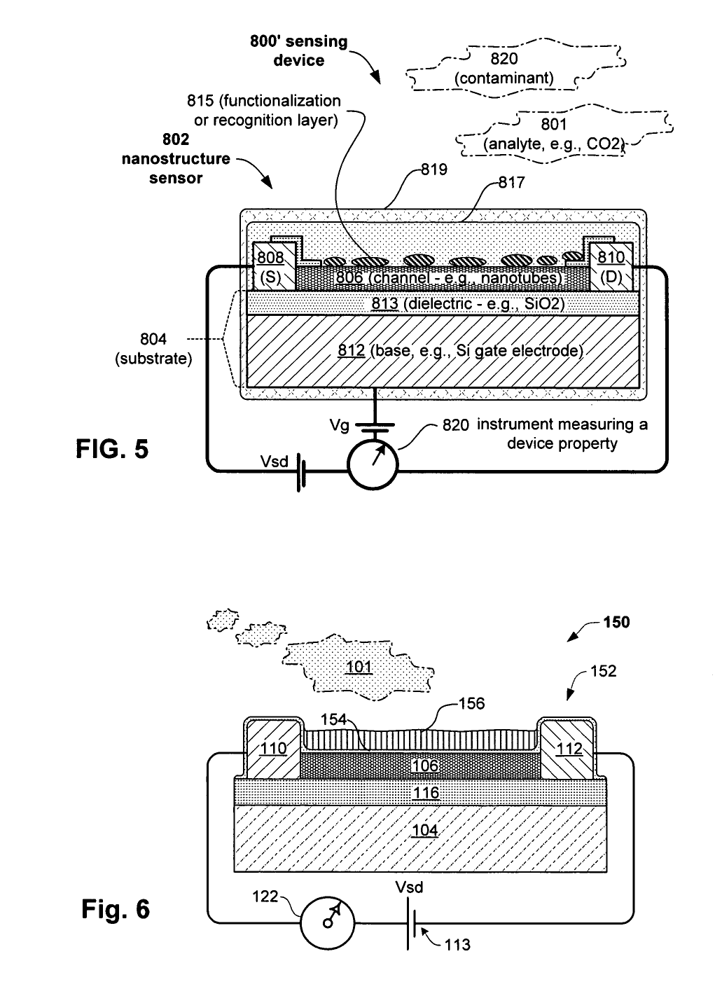

FIG. 5 schematically illustrates an electronic system 800 for detecting carbon dioxide 801, comprising a nanostructure sensing device 802, such as is described in U.S. patent application Ser. No. 10/940,324, which is incorporated by reference. Device 802 comprises a substrate 804, and a nanostructure 806 disposed adjacent the substrate. In an embodiment of the invention, nanostructure 806 may comprises one or more carbon nanotubes. Any other suitable nanostructure, such as a nanowire, nanofiber, or nanorod, may also be used, as described above with respect to FIG. 1. In an alternative embodiment, nanostructure 806 comprises an interconnected network of smaller nanostructures, such as a plurality of single walled carbon nanotubes forming an interconnecting mesh, film or network.

One or more conductive elements may be disposed over the substrate and electrically connected to nanostructure 806, such as elements 808, 810, and may comprise metal electrodes in direct contact with nanostructure 806. In the alternative, a conductive or semi-conducting material (not shown) may be interposed between elements 808, 810 and nanostructure 806. A functionalization material 815 reactive or responsive to one or more analytes of interest (e.g., carbon dioxide) may be disposed on nanostructure sensing device 802 and in particular, on nanostructure 806.

Material 815 may be deposited in a continuous layer, or in a discontinuous layer. Material 815 may comprise more than one material and/or more than one layer of material. Device 802 may further comprise a gate 812. For example, the gate 812 may comprise bulk doped silicon base material of the substrate, electrically isolated by a dielectric or insulating layer 813, e.g. SiO₂. Device 802 may further comprise a layer of inhibiting material 814 covering regions adjacent to the connections between the conductive elements 808, 810 and the first nanostructure 806. The inhibiting material may be impermeable to at least one chemical species, such as carbon dioxide. The inhibiting material may comprise a passivation material as known in the art, such as silicon dioxide. Further details concerning the use of inhibiting materials in a NTFET are described in prior application Ser. No. 10/280,265, filed Oct. 26, 2002, which is incorporated by reference herein.

In addition, system 800 may further comprise a second nanostructure sensing device (not shown) like device 802. It may be advantageous to provide the second device with a functionalization layer that incorporates a material different from that incorporated into layer 815. System 800 may further include a nanostructure sensing device circuit 816. Circuit 816 may include one or more electrical supplies 818, and an instrument 820 configured to measure one or more device properties, e.g., current, resistance, capacitance, impedance, hysteresis and/or the like. The instrument 820 is in electrical communication with the electrical supply or supplies 818, and electrical connections 822 between the first nanostructure sensing device 802 and both the electrical supply and the meter. System may further comprise a signal control and processing unit (not shown) as known in the art, in communication with the first nanostructure sensing device circuit.

Note that the structure and method illustrated in FIGS. 1 and 5 are exemplary, and a number of alternative structures and measurement methods are possible without departing from the spirit of the invention. For example, useful sensors having aspects of the invention may omit the application of a gate voltage to the substrate. Alternatively sensors may provide for measurement of transconductance of the nanostructure subject to a constant or variable source-drain voltage; may provide for measurement of a capacitance of the nanostructure via application of a voltage relative to the gate or other electrode; and/or may include a top gate, side gate, liquid media gate, counter electrode, reference electrode, and the like.

In other alternatives, an electronic device may contain a plurality or array of sensors (or other electronic functional components), preferably fabricated on a single “die” or sheet substrate portion. For example, different sensors may be employed to detect different analytes; may be employed for “pattern recognition” discrimination between chemically similar analytes; may be employed as a graded series of sensors to increase range of concentration sensitivity or precision; and/or as calibration, reference or redundant sensors; and the like. See, for example, U.S. patent application Ser. No. 10/388,701 filed Mar. 14, 2003 entitled “Modification Of Selectivity For Sensing For Nanostructure Device Arrays” (published as US 2003-0175,161) which is incorporated by reference.

In addition, the sensor may omit passivation material 814 on the contact regions, or alternatively may include further passivation material or passivation in association with other elements. In other alternatives, the sensor may include conducting or semiconducting elements to induce additional environmentally-sensitive Schottky barriers at metal/semiconductor junctions with the nanostructures, e.g. a carbon nanotube network may be decorated with metallic particles. See U.S. patent application Ser. No. 10/280,265 filed Oct. 26, 2002 entitled “Sensitivity Control For Nanotube Sensor” (published as US 2004-0043527); and U.S. patent application Ser. No. 10/945,803 filed Sep. 20, 2004 entitled “Multiple Nanoparticles Electrodeposited On Nanostructures”, both of which are incorporated by reference. In further alternative embodiments having aspects of the invention, the recognition layer 815 may include a plurality of distinct materials or particles; may be disposed upon all or only a portion of the nanostructures; and/or may be disposed on contact conductors, substrate, or as a spaced-apart layer that is electrochemically associated with the nanostructures, or the like.

Sensor 800′ includes optional layers or coatings 817 and 819. Layer 817 may be a material, such as a polymer, applied at the “wafer level” or sheet substrate level (e.g. a flexible substrate), whereby an arbitrary plurality of sensor devices are fabricated on a collective substrate (note that a discrete die may include more than one electronic device, such as an array of sensors). Typically such devices or “dies” are subsequently cut, broken or otherwise separated from the bulk wafer or substrate sheet for final packaging and/or integration into an operational electronic system. Note that techniques such as masking, ink jet and/or drop-on-demand printing may be employed to restrict layer 817 to portions of the device if complete coverage is not desired.

Layer or coating 819 may be a material, such as a polymer, applied at the “die” level or separated substrate portion level. This permits encapsulation for the sensor as a unit, for example, a hydrophobic or water-resistant layer to protect substrate, contacts, nanostructures and recognition layer from moisture or another undesired species.

Either or both of layers 817 and 819 may be selected or configured to (a) permit the diffusion or penetration of a particular species (e.g., the analyte of interest) and/or (b) exclude, repel, deactivate or absorb a particular species (e.g., a contaminant or cross-reacting molecule).

Detection with Electrical Isolation of Nanostructures from Sample Media (ALD).

As described above, a nanostructure sensor element may by passivated or protected by the use of an inhibiting material, for example, an inorganic oxide coating all or a portion of a carbon nanotube network channel. See the above referenced U.S. Pat. No. 6,894,359.

A preferred CO₂ nanosensor embodiment comprises a continuous coating of an oxide, nitride or other compound disposed over a carbon nanotube network channel by atomic layer deposition methods (ALD). ALD permits the coating layer to be extremely thin and uniform, while at the same time avoiding pores, shadowing or other discontinuities/irregularities in the coating. ALD is one alternative approach to producing a layer having these desirable qualities. Alternative methods may be used, such as thermal and e-beam evaporation. Additional process elements may be included to improve coating properties, such as rotating and/or tilting a substrate during evaporation.

FIG. 6 shows an example of a nanosensor 150 having aspects of the invention having an electrical isolation layer 154 coating a nanostructure channel 106. The nanosensor 150 has an archetecture 152 which is generally similar the example for FIG. 1 and consequently many of the same reference numerals are indicated. In a preferred embodiment, isolation layer 154 comprises a ALD coating of Al₂O₃. Layer 154 may have a thickness of about 20 nm, but substantially thicker and thinner layers may be used.

A CO₂ accumulation material 156 is disposed upon layer 154. Material 156 may include one or more of the materials described above in TABLE 1. For example, material 156 may comprise an aqueous suspension of carbonic anhydrase bound in a matrix of PAMAM hydrogel. In one embodiment, exposure to carbon dioxide causes a reduction in the pH of material 154, causing a gating effect (or induced charge) on channel 106, SO as to produce a measurable change in the conductivity of channel 106. In the example of FIG. 5, source-drain measurement circuitry 122/113 is shown, but other measurement strategies and properties are possible, such as are described with respect to FIG. 1.

Layer 154 is configured so as to create an electrical isolation (dielectric) to inhibit or reduce the flow of charge carriers (e.g., electrons or ions) between material 156 and channel 106. For this reason, non-selective reactivity of the channel 106 with the environment is inhibited, and the selectivity of sensor 150 to an analyte of interest (in the example CO₂) is provided by the chemistry of material 154. Additional elements may be included in sensor 150 to promote selectivity (as constituents in material 156 or as distinct components), including filters, absorbents, selectively reactive compounds, redox modifiers, buffers, and the like.

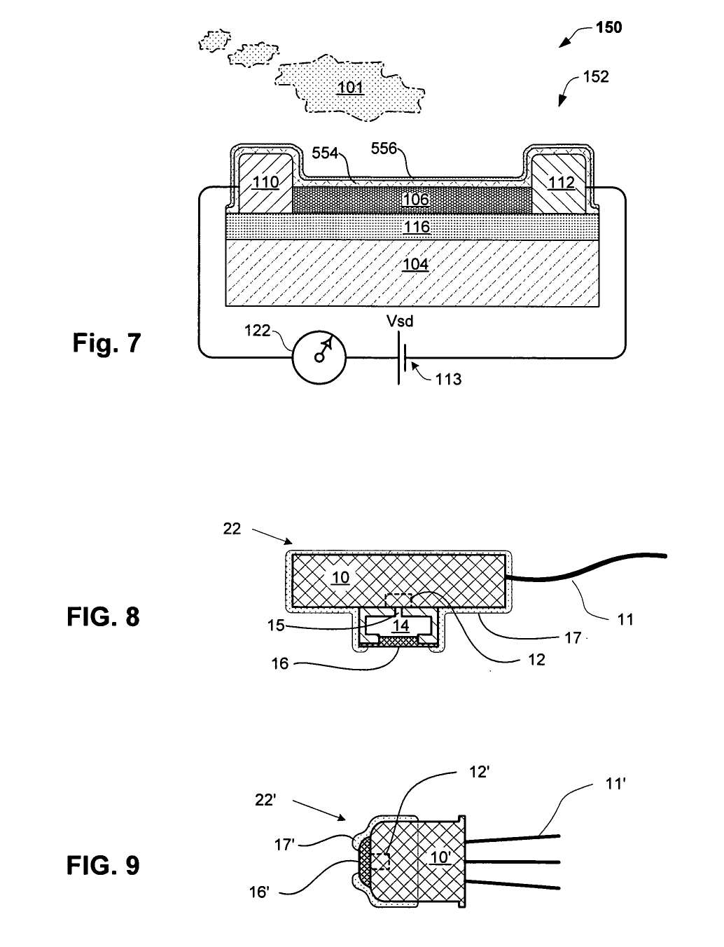

ALD also permits the convenient and controlled application of multiple layers, for example, a composite coating having a plurality of layers of differing material properties. FIG. 7 shows an example of a nanosensor 150 having a multilayer coating comprising layers 554 and 556. For example, layer 554 may be a material with a selective reactivity with an analyte of interest, such as CO₂. Layer 556 may be a semi-permeable layer permitting the diffusion of an analyte of interest, while inhibiting the passage of at least one contaminant or cross-reactive species. Note that the example of FIG. 7 illustrates a pair of source-drain electrodes 110, 112, but alternative circuitry, electrodes, and measurement principles may be employed as described with respect to FIG.

In alternative embodiments, layer 154 need not be entirely isolating, but may act to permit selective chemical influence upon channel 106. For example, layer 154 may comprise a composite or multi-layer structure selectively reaction with a species of interest, or selectively inhibiting a cross contaminant species.

Further description of ALD methods may by found in P. Chen, et al, “Atomic Layer Deposition to Fine-Tune the Surface Properties and Diameters of Fabricated Nanopores”, Nano Lett (June 2004) Vol. 4, No. 7, pp 1333-37; D. Farmer et al, “Atomic Layer Deposition on Suspended Single-Walled Carbon Nanotubes via Gas-Phase Noncovalent Functionalization”, Nano Lett (March 2006) Vol. 6, No. 4, pp 699-703; and M. Groner et al, “Gas diffusion barriers on polymers using Al2O3 atomic layer deposition”, Appl. Phys. Lett. (2006) Vol. 88, pp 051907-1 to -3; which publications are incorporated by reference.

### Accelerators for Improved Nanosensor CO₂ Response

It is desirable in many respiratory medical applications to be able to detect breath CO₂ concentration at a time resolution equal to a small fraction of the respiratory rate or breathing cycle. Accelerants or catalysts may be employed to improve the response of nanosensors having aspects of the invention. In one embodiment, catalysts are used to accelerate the conversion of CO₂ in aqueous solution to carbonic acid. This reaction can produce an alteration in ambient pH so as to change a detectable property of the sensor, e.g. the conductance an carbon nanotube.

Such a sensor with may be employed for either or both of detection of CO₂ in both gaseous or liquid sample media. For example, in one example of a respiratory sensor embodiment having aspects of the invention, an expired breath sample stream is directed into contact with a sensor package, and the following sequence of reactions may occur:
1. Gaseous CO₂ from the breath diffuses into a sensor structure containing water (e.g., H₂O bound in a hydrogel matrix adjacent a nanotube network):
   CO₂(g)←→CO₂(aq)
2. The CO2 reacts with water forming a carbonic acid:
   H₂O+CO₂(aq)←→H₂CO₃
3. The carbonic acid dissociates:
   H₂CO₃←→H⁺+HCO₃⁻
4. A cumulative modulation of pH occurs as the H⁺ increases to an equilibrium concentration:
   pH=−log[H⁺]
5. A change in a nanosensor electrical property is measured in response to modulation of pH (e.g., change in conductance of a nanotube network between a source and drain electrode pair).

Reaction 2. above is often found to be a rate-limiting step in sensor performance. It has been found that an enzyme such as carbonic anhydrase may be incorporated into a nanosensor as described herein, so as to accelerate the conversion of dissolved CO₂ to carbonic acid. Such enzymes are important in living organisms to improve gas exchange processes. In one embodiment, a nanosensor comprises carbonic anhydrase is suspended in an appropriate buffer bound in a hydrogel matrix such as PAMAM, and disposed adjacent a carbon nanotube network. The effect of the enzyme can be dramatic: it has been found that the carbonic anhydrase can increase sensor response rate by 3 orders of magnitude or more, e.g., as measured by the rate of change of conductance of the nanotube network.

Further useful description may by found in J. Shin et al, “A Planar pCO2 Sensor with Enhanced Electrochemical Properties”, Anal. Chem. (2000), Vol. 72, pp 4468-73; which publication is incorporated by reference. Analogs to carbonic anhydrase, such as catalysts (e.g., Zn-[12]aneN3) may be similarly employed to increase the rate conversion of CO₂ to carbonic acid by reaction 2 above. See for example the analogs and catalysts active on carbon dioxide as a substrate, as described in the following: G. Parkin, “Synthetic Analogues Relevant to the Structure and Function of Zinc Enzymes”, Chem. Rev. 2004, 104, 699-767; E. Kimura et al, “A Zinc(11) Complex of 1,5,9-Triazacyclododecane ([12]aneN3) as a Model for Carbonic Anhydrase”, J. Am. Chem. Soc. 1990, 112, 5805-11; Joseph E Coleman, “Zinc enzymes”, review in “Bio-inorganic chemistry”, pp 222-234.

Similar principles may be usefully employed in nanosensors having aspects of the invention for the detection of such species as ammonia, nitric oxide, carbon monoxide, methane, and the like, to improve sensor response by enzymatic or catalytic acceleration of rate-limiting reaction steps.

For example, transition metal catalysts may be used to accelerate the conversion of breath NO to NO₂ in a nanosensor having aspects of the inventions, wherein a sensor property is altered in the presence of NO₂.

### Alternative Nanoelectronic Sensor Configurations

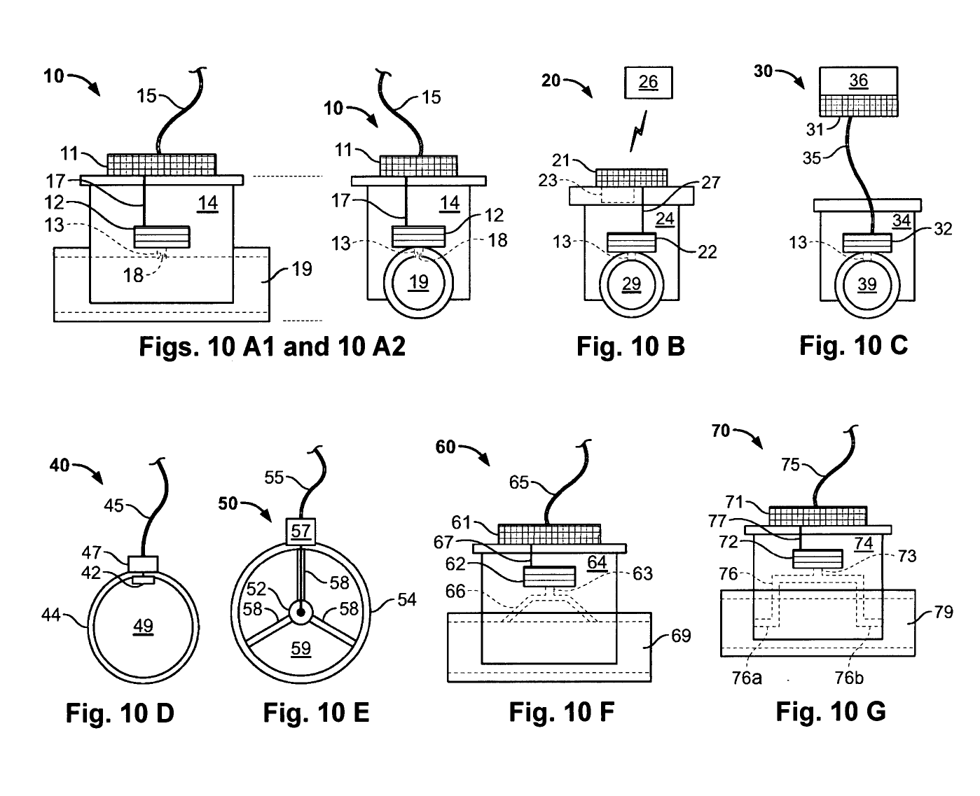

FIGS. 8 and 9 schematically illustrates an exemplary embodiments of a sensor devices 22 and 22′ having aspects of the invention, and adapted to measure CO₂. As shown in FIG. 22, sensor device 22 is generally similar to sensors described in the above mentioned U.S. patent application Ser. No. 11/019,792, which is incorporated by reference. The exemplary sensor device having aspects of the invention includes a packaged sensor chip 10 having one or more (preferably moisture resistant) signal and/or power conductors 11 extending outward (e.g., to connect via flexible cable 26 to measurement instrument 30, as shown in FIG. 10A). Chip package 10 has a sensor opening 12 for communication of analyte media.

In this example, a plenum 14 is mounted adjacent chip package 10, having a pore 15 communication with sensor opening 12. Plenum 14 has a gas-permeable membrane 16 mounted so as to communicate between plenum 14 and the adjacent external environment. The gas-permeable membrane 16 includes a material known in the art and selected so as to permit the diffusion of at least an analyte of interest, in this example carbon dioxide. The analyte of interest is permitted to diffuse through membrane 16, through plenum 14 and pore 15 to sensor package 12. The gas-permeable membrane 16 may include a material known in the art and selected to exclude species other than the analyte of interest, for example, aqueous fluids such as saliva. For example, the gas-permeable membrane 16 may be a hydrophobic polymer. Additional encapsulation material 17 may be included. Optionally sensor device 22 may include other elements such as filters, absorbents and the like (not shown) to condition analyte media prior to communication with the sensor, e.g. to exclude, repel, deactivate or absorb a particular species (e.g., a contaminant or cross-reacting molecule).

FIG. 9 schematically illustrates an alternative example of a sensor device 22′ having aspects of the invention packaged as a discrete sensor component. The components that are similar in form and function to the device of FIG. 22 are denoted by the same number, modified by an apostrophe. In this alternative embodiment, the gas-permeable membrane 16′ is mounted so as to cover opening 12′.

FIGS. 10A to 10G depict a number of different embodiments, in which the same or generally similar elements are identified by numbers, in which the last digit corresponds to the equivalent or corresponding element, as much as possible, in each figure, with the digits preceding the last digit corresponding to the figure number of each example embodiment.

Referring to FIGS. 10A1 to 10A2, in an exemplary embodiment having aspects of the invention, the unit may be configured like conventional airway adapters, with an input and output for connecting tubing to an air channel 19 running through a housing 14. One opening of housing 14 may be fed by the patient's respiration and the other opening may be connected to the breathing or anesthesia circuit. The adapter 10 may be connected to a power and signal cable 15. Cable 15 may be used to relay gas monitoring data to the display unit, as well as powering the sensor. The cable may be directly connected to an electronics module 11. This module may be configured for signal processing, analysis, and delivery of data values/waveforms to users. Module 11 contain a microprocessor with embedded software and backup battery power. The electronics module may be located above and connected by connector 17 to a solid-state sensor 12 (e.g., a nanoelectronic capnometer sensor such as is disclosed in application Ser. No. 10/940,324). Module 11 may be configured to readily detach and reattach, facilitating replacement of the sensor-containing adapter 14. Electronics module 11 and sensor 12 may be provided on a single unitary semiconductor device, for example, a silicon chip, if desired.

The nanoelectronic sensor 12 may be disposed in fluid communication with respired air passing through channel 19. In order to provide a sample volume to the capnometer, a small window or opening may be provided between the sensor 12 and channel 19. The sample window may be provided with membranes and/or filters 18 to reduce condensation, block patient secretions, and overall maintain stability of the sensor. For example a gas-permeable hydrophobic membrane, e.g. a PFC membrane, may be used.

When using a nanotube electronic sensor, it is not necessary to maintain a clear optical path between a transmitter and receiver, unlike prior-art NDIR sensors for carbon dioxide sensing. Furthermore, the active sensing area of a nanotube sensor is extremely small, so one may readily protect the sensor from contamination in the patient airstream. For example, very little power is required to heat the sensor to a stable temperature at which condensation is prevented. And the sensor may be protected from non-volatile contaminants by a simple mechanical filter and/or gas permeable membrane, which need only be large enough to minimize the likelihood of excessive filter blockage during the anticipated life of the sensor. For reusable sensors, filter units may be removed and disposed between use, and then replaced with a new filter unit. For most applications, however, it may be desirable to dispose and replace the entire unit 10, including any associated filters.

The unit 10 may be comprised primarily of a mechanically stable housing 14. Housing 14 may be comprised of any suitable plastic or other material with similar chemical and physical properties for use in medical tube fittings, as known in the art.

The capnometer sensor 12 may be based on nanoscale components as described in the parent patent application Ser. No. 10/940,323 and herein, for selectively sensing carbon dioxide. Sensing of other gases may also be achieved using a suitably configured nanotube sensor, for example, a sensor as described in U.S. provisional applications Ser. No. 60/457,697 filed Mar. 2003 and Ser. No. 60/468,621 filed May 2003, and U.S. non-provisional application Ser. No. 10/177,929 filed June, 2002, Ser. No. 10/656,898 filed Sep. 5, 2003, Ser. No. 10/655,529 filed Sep. 4, 2003, Ser. No. 10/388,701 filed Mar. 14, 2003, and Ser. No. 10/345,783 filed Jan. 16, 2003; each of which is incorporated herein by reference.

Sensing for two or more gases, for example, carbon dioxide and oxygen, may be accomplished using one or more sensors like sensor 12. A single sensor may include a plurality of nanotube sensors, each configured to sense a different gas. In addition, or in the alternative, a plurality of nanotube sensors may be each configured to sense the same gas, for purposes of redundancy. It should be appreciated that the extremely small scale of a nanotube sensor makes it possible to cost-effectively incorporate numerous nanometer-scale sensors in a single gas sensing unit 12, which may essentially consist of a very compact silicon chip or other device. In the alternative, one or more nanotube sensing devices may be assembled together into a sensing unit with multiple sensors. Since each device may be quite small, space and/or cost need not be limiting concerns.

A capnometer according to the invention may readily be configured to operate wirelessly. FIG. 10B shows a wireless unit 20 without a need for a power or signal cable. To compensate for this alteration, one can implement wireless communication capabilities into the electronics module 21 for wireless communication to a base station 26. Since the capnometer 22 uses little power, an on-board miniature battery 23 may provide sufficient power for its lifetime. Housing 24 and channel 29 may be configured similarly as in capnometer 10.

In the alternative, a capnometer 30 may be designed to function with all electronics 31 separate from the sensor 32, as shown in FIG. 10C. Here the sensor 32 has a cable that connects it to the electronics module 31, which is located remotely. For example, module 31 may be incorporated into a display and base station 36, which may be reused with different capnometer units 30. Base station 36 may then incorporate more complex hardware and software for capnography, for example, display or analysis systems. Signal and power cord 35 to the sensor may be removably connected to unit 30, allowing only the sensor unit 30 to be discarded and replaced.

It also is desirable to provide disposable capnometer sensing adaptors, wherein the sensing package is installed directly in the main air channel of the respiratory stream. FIGS. 10D and 10E show exemplary embodiments of this type. FIG. 10D shows a capnometer sensing and airflow adaptor unit 40, comprising a tubular adaptor 44 with internal air channel 49. Nanoelectric unit 42 may be mounted to the wall of channel 49, and connected to a cable connector 47 mounted on the outside of adaptor 44 by a wire. It is possible, for example, to integrate sensing unit 42 and its connecting wires into the adaptor 44 during a plastic molding process, thereby minimizing the possibility for leakage into or out of channel 49 adjacent to the sensor 42. Sensor 42 may comprise a nanotube device as described above. It may be protected from contamination by a suitable filter and/or gas-permeable membrane (not shown) disposed around or over the sensor. For example, one may encapsulate sensor 12 in a gas-permeable membrane material, and/or a suitable filter and/or membrane may be separately mounted in channel 49.

Alternatively, one may dispose the sensing unit more directly in the airstream. For example, FIG. 10E shows a capnometer sensor and adaptor 50, wherein a nanoelectric sensor 52 is mounted in the center of channel 59 using a plurality of ribs 58. Ribs 58 may be molded integrally with sensor 52 and/or adaptor housing 54, with a molded-in connection to cable 55. In the alternative, ribs 58 and sensor 52 may comprise a sub-assembly that is later assembled in housing 54. Such a sub-assembly may attach to a molded-in electrical connector (not shown) passing through the wall of housing 54. It should be apparent that either design would virtually eliminate the possibility for inaccurate sensor readings from outside air leakage. Ribs 58 or any other suitable mounting structures for sensor 52 may also be used to hold protective filters and membranes around sensor 52. Such a design may be particularly suitable for monitoring respiration from a subject in blow-testing equipment such as used for blood-alcohol testing and the like.

FIG. 10F is a schematic diagram showing a side view of a capnometer sensor and adapter 30 generally similar to that shown in FIGS. 10A1 to 10A2, but having a sensor 62 arranged adjacent a secondary parallel lumen 66 in communication with the airway passage 69. Window or opening 63 communicates to parallel lumen 66 directly, and is in only indirect communication with passage 69.

FIG. 10G is a schematic diagram showing a side view of a capnometer sensor and adapter generally similar to that shown in FIG. 10F, but having inlet and outlet ends 66a and 76b of the secondary parallel lumen 76 projecting into airway passage 79 into the exhalation flow path.

Note that the examples of FIGS. 10F and 10G show the parallel lumen arranged close to the adaptor housing and primary passage. Alternatively, the parallel lumen may be extended, so that senor, electronic circuitry, displays, and/or data memory are located remotely from the airway.

Embodiments of this invention include a new sensing technology for carbon dioxide (CO₂) that uses nanoelectronic components. A tiny, low-cost nanosensor chip can offer: (i) performance that matches or exceeds that of infrared technology, (ii) plug-and-play simplicity with both digital and analog control systems, and (ii) the small size and low power consumption needed for wireless integration.

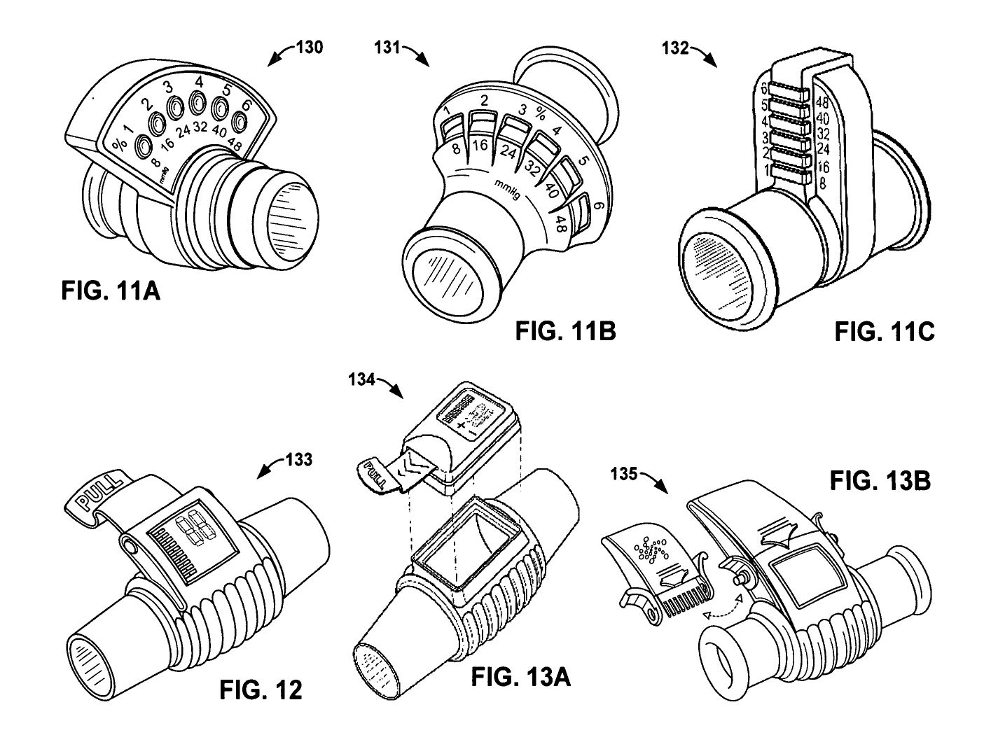

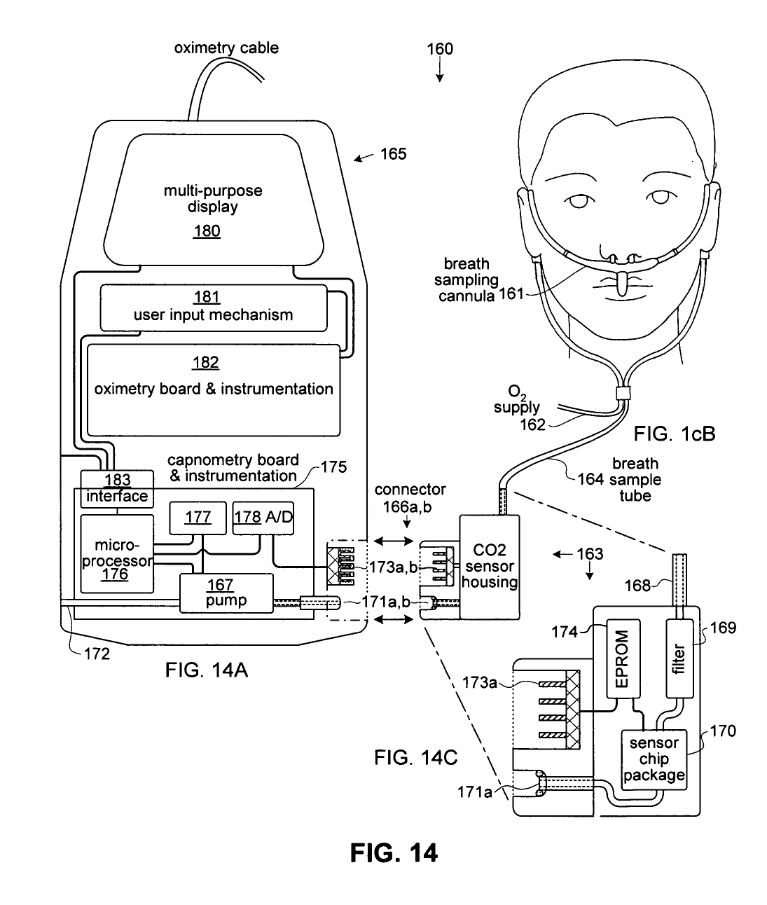

FIGS. 11A, 11B and 11C depict exemplary configurations of capnometer adaptor 130, 131, and 132 respectively, in which the output device is mounted to the adapter housing and displays a quantitative bar graph. The sensor mounting may be as in any one of FIGS. 10A-G, the electronic output of the sensor (or plurality or array of sensors) permits a variety of alternative display or other user-interface modes. For examples, LEDs provide an inexpensive, reliable and low-power means of communicating with a user. A color-coded display (e.g., red-yellow-green LEDs lighting depending on CO₂ concentration) provides a user with a quickly identifiable indication of respiratory function readable even under difficult and stressful emergency conditions, such as an EMT confirming proper placement of emergency intubation via exprired CO₂ content.

FIG. 12 depicts an exemplary configuration of a capnometer adaptor, in which the output device is mounted to the adapter housing and displays a both a digital reading and a quantitative bar graph. Optionally, a pull tab or other simple mechanism may be used to activate and unseal the device.

FIGS. 13A and 13B depict exemplary configurations of a capnometer adaptors, in which either one or both of the sensor (FIG. 13A) and the electronic circuitry (FIG. 13B) is separately detachable from the airway adaptor housing. These arrangements permits a sensor or circuitry to be replaced without disturbing airway tubing, and/or to be replaced separately from disposable airway components. In the example of FIG. 13B the electronic circuitry is separately detachable from the airway adaptor housing without removing the sensor.

Note that capnometers having aspects of the invention may include a wide variety of data acquisition, storage, processing and output devices. For example, the capnometer signal may be used to determine respiration rate, and inhaled gas composition, in addition to exhaled breath composition, such as end-tidal CO₂ values. In addition to discrete point values, a real-time and continuous profile of breath composition may be determined and displayed, e.g. as a plot of CO₂ concentration versus time.

### MEDICAL ANALYSIS SYSTEM, EXAMPLE A—BREATH SAMPLING CANNULA

FIG. 14 is a diagrammatic depiction of an exemplary configuration of a portable medical gas sensing system 160, including three linked portions: FIG. 14A depicting a processor unit 165, FIG. 14B showing sampling cannula 161 worn by a patient, and FIG. 14C showing an enlarged view of sensor unit 163. Note that the figures includes both surface and internal elements, diagramed to clarify functional relationships rather than show realistic physical appearance.

Preferred embodiments may optionally include other complementary chemistry measurements relevant to the patient's care in addition to breath analytes, such as pulse oximetry and the like. The exemplary embodiment of FIG. 14 is shown integrated with a portable oximetry system, for example, such as the 920M™ PLUS and 9600 Avant™ pulse oximetry systems by Respironics, Inc., of Murrysville, Pa.; the Rad-5™ and Rad-57™ pulse oximetry systems by Masimo Corporation, Irvine, Calif.; or the OxiMax® NPB-40 and OxiMax® NPB-75 pulse oximetry systems by Nellcor Puritan Bennett, Inc., Pleasanton, Calif. Additional components for such other analyte systems (e.g., finger-mounted adaptors for oxymetry and the like) are not shown.

As shown in FIG. 14, the sensing system 160 comprises breath sampling cannula 161 connected to supplemental oxygen (O₂) source 162 and also connected to sensor unit 163 by breath sample tube 164. Sensor unit 163 in turn communicates with portable processor/instrumentation/interface/input/display unit (“processor unit”) 165 by means of signal/suction connector 166.

In operation, a breath sample is drawn from cannula 161 by action of vacuum or suction pump 167 (preferably housed in processor unit 165), through a fluidic circuit comprising in flow sequence (with suitable conventional interconnect tubing and fittings): sample tube 164, sensor housing inlet 168, optional pre-conditioner or filter 169, sensor chip package 170, and suction mating seal pair 171, 171b on connector 166, and then to suction pump 167. The suction pump 167 expels the expended breath sample via exhaust port 172. The fluidic circuit describe is preferably dimensioned and configured to minimize “dead volume”. One or more of sensor unit 163, sample tube 164 and cannula 161 is preferably made disposable, e.g., to eliminate cross-contamination/service issues.

Turning to the enlarged view of sensor unit 163, pre-conditioner or filter (“filter”) 169 may include one or more of absorbents, filters, semi-permeable membranes, and the like, to precondition the breath sample prior to sensor contact. For example, the filter may remove excess fluid or condensation from the sample, and/or may remove selected gas constituents from the sample.

Sensor chip package 170 comprises one or more nanoelectronic sensors, such as are described above and in the applications incorporated by reference. The sensors may have sensitivity and/or selectivity for one or more analytes of medical interest, in this example for CO₂. The sensor (or sensors) is exposed to the breath sample in a manner such as is described above with respect to alternative configurations of airway adaptors (detail not shown in FIG. 14). It should be understood that an optimum sensor-sample contact configuration may depend on such factors as the nature of the analyte of interest, the duration of service intended, the sampling protocol (e.g., measured sample duration, frequency or breathing cycle timing), and the like. A number of alternative sensor-sample contact configurations may be employed in sensor package 170 without departing from the spirit of the invention.

The sensor of sensor package 170 communicate via suitable cables or busses through the mating signal connector elements 173a, 173b with processor unit 165. Optionally the sensor unit 163 may include additional circuitry and/or devices, such as EPROM 174. In certain preferred embodiments of the sensing system 160, EPROM 174 stores calibration data specific to the sensor (or sensors) of sensor package 170. Signals from the sensors may optionally be pre-processed within sensor unit 163.

For manufacturing and servicing convenience, the processor unit 165 preferably includes a dedicated breath sensing or capnography board 175. In a certain embodiments, board 175 (and/or equivalent distributed components), includes a microprocessor 176 and power supply 177. Signals transmitted from sensor unit 163 pass (e.g., through A/D converter 178) to microprocessor 176 by suitable transmission circuitry. For example, sensor-specific calibration coefficients may be read by microprocessor 176 from EPROM 174. The microprocessor 176 may read a sensor signal received, via A/D converter 178, produced by a sensor of sensor package 170 in response to a breath sample. The microprocessor 176 may use the coefficients to calibrate the sensor signal so as to accurately reflect concentration of an analyte of interest, such as CO₂, in the breath sample.

In certain embodiments, the microprocessor 176 may select a sensor signal by a protocol configured to ignore sampling the “dead volume” of the fluidic circuit upstream of sensor package 170. In certain embodiments, the microprocessor 176 may be configured to determine a breathing cycle of the patient (either from measured sensor signals or other detectors), and select sensor signals corresponding to particular portions of the patient's breathing cycle.

The microprocessor 176 may optionally regulate the suction pump 167 to control breath sample flow to achieve a pre-selected sampling protocol. Alternatively, other fluidic elements, such as valves (not shown, but for example mounted on board 175 or in sensor unit 163) may be employed to control sample flow. For example, the suction pump rate may be increased at certain times to rapidly clear “dead volume” at the beginning of an exhalation prior to a lower sustained flow rate during the course of the exhalation.

The microprocessor 176 is shown in communication via interface connector 179 with display unit 180 and user input mechanism 181. For example, display unit 180 may include an LCD or other display for output of sensor measurements, user-specific configurations, complementary oximetry results from oximetry board 182, and the like. User input mechanism 181 may include a plurality of dedicated buttons and/or a “generic” keypad to permit user control, programming and configuration. Optional user interface elements (not shown) may also include auditory or light outputs and alarms, and may include auditory or light inputs, such as voice command recognition, IR data downloading, and the like

The microprocessor 176 preferably communicates via an external connector 183 to permit transfer of data to and/or from external sources, such as remote monitoring and recording units. Alternatively, unit 165 may include wireless or RF communication elements (not shown) in communication with microprocessor 176 so as to permit external data exchange.

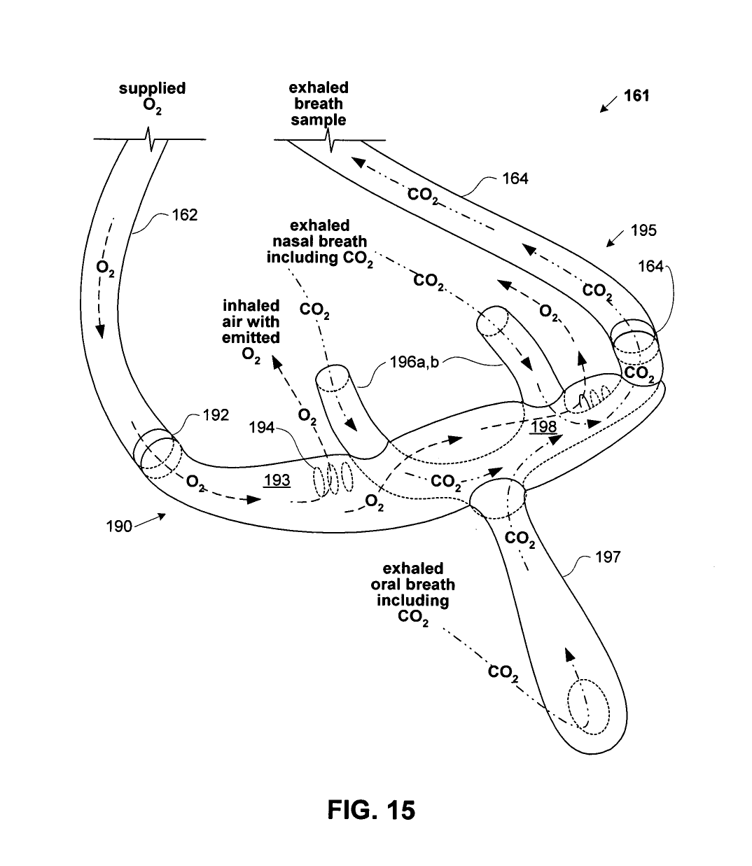

FIG. 15 is a perspective drawing which depicts the arrangement of the breath sampling cannula 161 included in FIG. 14B. Breath sampling cannula 161 includes a supplemental oxygen fluidic circuit (“oxygen circuit”) 190 and an exhaled oral and nasal breath sampling fluidic circuit (“sample circuit”) 195. (Note that a cannula breath sampler generally similar to that of FIG. 15 may be configured without supplemental O₂).

Oxygen circuit 190 comprises an oxygen supply tube 191 connecting to a central oxygen plenum 193 via an optional releasable connector or ferule 192. The oxygen plenum 193 spans the width to the patient's nose (see FIG. 14B), and oxygen is emitted through a plurality of pores or nozzles 194 in proximity to the patient's nostrils, so as to mix with inhaled air. The supply tube 191 is shown in this example as leading to one side, passing over a patient's right ear. Alternatively, the supply tube may be bilateral, it need not be arranged to pass over the ears and it may be supported by accessories, such as a headband, elastic straps, ear loops, and the like.

Sample circuit 195 comprises a space-apart right/left pair of nostril tubes 196a, 196b, which also serve to position the cannula as a unit with respect to the patients nostrils. The nostril tubes 196 extend a short distance and open into the right and left nostrils, and are preferably sized to permit comfortable and free nostril inhalation around the tubes. Optionally, an oral tube 197 extends medially and downward and opening into proximity of the patients mouth. Tubes 196 and 197 are arranged to gather a portion of the patient's nasal and oral exhaled breath respectively and conduct the portion to a central sample tube or plenum 198. Sample plenum 198 communicates with breath sample tube 164, via an optional releasable connector or ferule 199, e.g., for conduction to the sensor unit and suction pump as shown in FIG. 14. The sample tube 164 is shown passing over the patient's left ear, but may be arranged or supported alternatively, as described with respect to oxygen supply tube 191.

In the exemplary embodiment shown, the, the oxygen circuit 190 and sample circuit 195 are arranged in an “interlaced” configuration, but maintain distinct internal flow paths, the oxygen plenum 193 forming an overall support and stiffening element. Alternatively the oxygen circuit 190 and sample circuit 195 may be arranged and supported separately. As shown, the sample circuit 195 is arranged in relation to the patient's nasal breath flow so as to directly gather little or none of the emitted oxygen from ports 194, the supplemental oxygen (or other administered gas) only materially entering the breath sample either as residual exhaled oxygen from the patient's lungs, or as a mixed constituent of the patient's tracheal/airway “dead volume” exhalation.

### MEDICAL ANALYSIS SYSTEM, EXAMPLE B—INTEGRATED CO₂ SENSING CANNULA

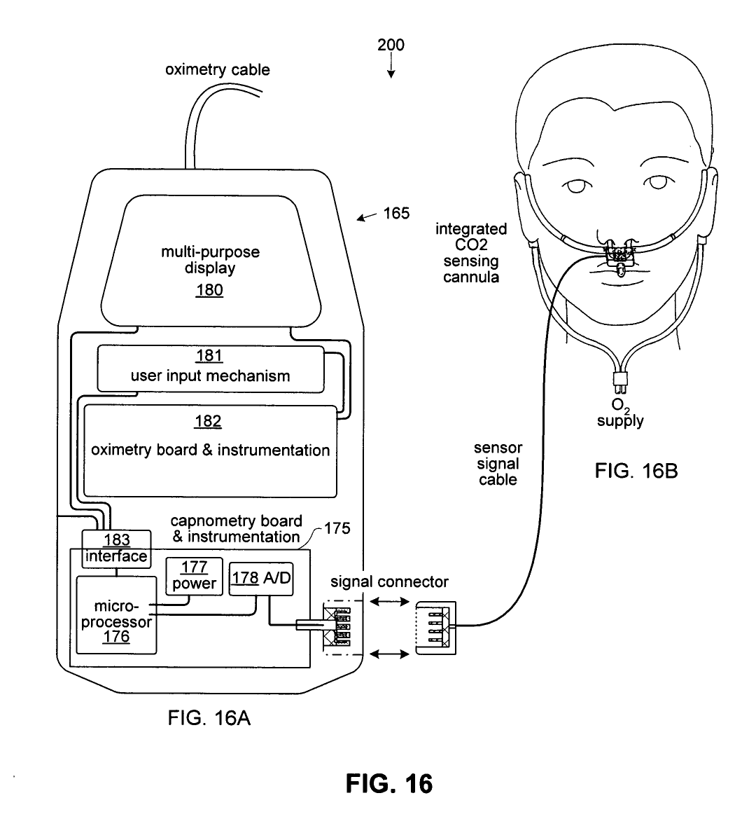

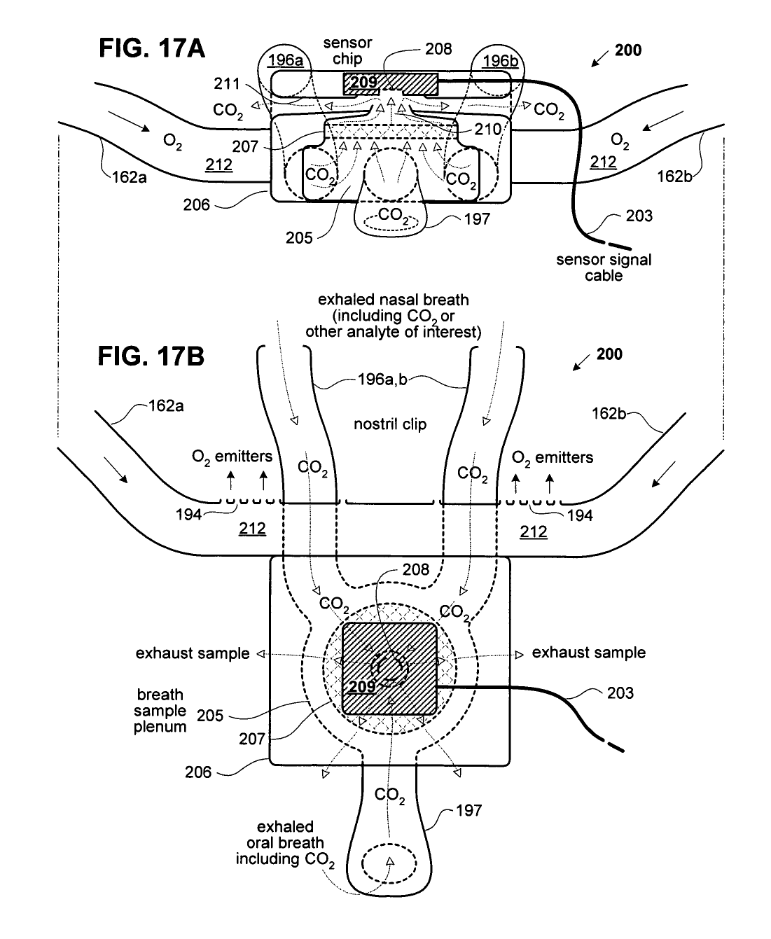

FIG. 16 is a diagrammatic depiction of an exemplary configuration of a portable medical gas analysis system 200, including two linked portions: FIG. 16A depicting a processor unit 201, and FIG. 16B showing integrated sensing cannula 202 worn by a patient. Note that the figures includes both surface and internal elements, diagramed to clarify functional relationships rather than show realistic physical appearance. For clarity and convenience, where elements in FIGS. 16 and 17 serve a similar function corresponding to those shown in FIGS. 14 and 15, the same reference numbers are used, and the description of FIGS. 14 and 15 is to be noted.

As shown in FIG. 16, the sensing system 200 comprises integrated sensing cannula 202 connected to supplemental oxygen (O₂) source 162 and also connected to processor unit 201 by sensor signal cable 203 and signal connector 204.

FIGS. 17A and 17B are a cross-section and top view respectively of the integrated CO₂ sensing, O₂ delivery cannula 201, included in FIG. 16. In operation, during patient exhalation, one or both of a nasal breath sample or an oral breath sample enters the sensing cannula 201, containing a variety of analytes of potential medical interest, such as CO₂. The velocity and pressure of the exhaled nasal breath causes a sample to enter nostril tubes 196a,b and pass into central sample plenum 205 within cannula body 206. Similarly, the velocity and pressure of exhaled oral breath causes a sample to enter oral tube 197 and pass into central sample plenum 205 to mix with the nasal sample.

The mixed breath sample then flows through optional preconditioner 207, housed adjacent to and communicating with plenum 205. As in the previous example, pre-conditioner or filter (“filter”) 207 may include one or more of absorbents, filters, semi-permeable membranes, and the like, to precondition the breath sample prior to sensor contact.

The breath sample next conducted to impinge or contact opening 208 in sensor chip package 209, in this example, the breath being guided and directed by nozzle 210. The sensor chip package 209 may be configured as in the examples described elsewhere in the present application, or in the references incorporated herein, and includes one or more sensors configured to respond to at least one analyte of interest, so as to produce at least one sensor signal. The sensor signal is transmitted to processor unit 201 via signal cable 203 (note that alternative embodiments may include wireless transmission elements, not shown, to pass the sensor signal to the processor unit 201). The sensor chip package 209 may include an array of sensors and may include sensors specific to different analytes, as described above and in the incorporated references.

Following sensor contact, the exhaled breath sample flows through annular space 211 to exhaust through the sides of cannula body 206

In the particular embodiment shown in FIGS. 17A and 17B, the cannula 202 includes an oxygen plenum 212 fed by dual supply tube 162a,b from the left and right sides of patient. A plurality of oxygen emitters 194 add supplemental oxygen to the inhaled air adjacent patients nostril entrance.

Note that the incorporation of sensor package 209 in cannula 202 provides a number of important advantages. The internal “dead volume” of the measurement equipment is dramatically reduced, since there is no need to convey the breath sample to a remote sensor. In addition, the close proximity of the sensor package 209 to the patients nostrils and mouth assure that there is minimal time delay between exhalation and sensor contact. Nanoelectronic sensors having aspects of the invention are suitable for large scale, inexpensive production, making it feasible to products cannula 202 (and optionally with 203 and connector 204) as a pre-sterilized disposable unit.

### ALTERNATIVE INTEGRATED CO₂ SENSING CANNULA FOR MEDICAL ANALYSIS SYSTEM, EXAMPLE C

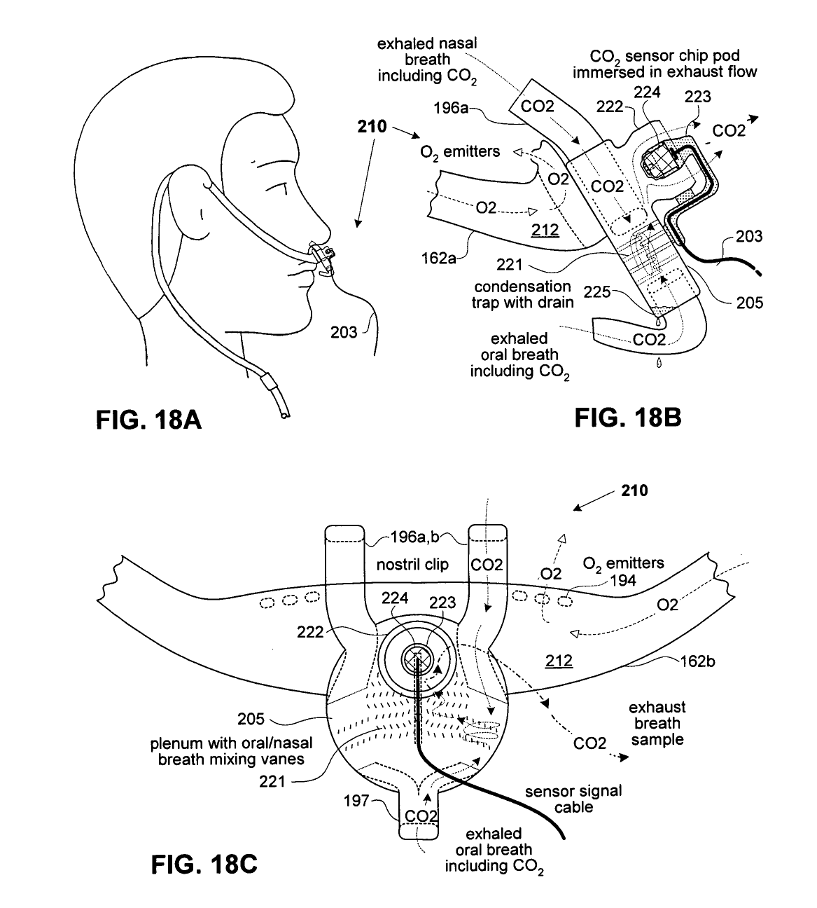

FIGS. 18 A, B, and C show an alternative embodiment of an integrated sensing cannula 220. FIG. 18A illustrates the cannula 220 worn by a patient, FIGS. 20B and 20C are a cross section and top view of the cannula 220 respectively. Note that the figures includes both surface and internal elements, diagramed to clarify functional relationships rather than show realistic physical appearance. For clarity and convenience, where elements in FIG. 18 serve a similar function corresponding to those shown in FIG. 14 through 17, the same reference numbers are used, and the description of FIGS. 14 and 15 is to be noted.

During patient use, the mode of operation of cannula 220 is generally similar the cannula 200 shown in FIGS. 16 and 17. Nasal and/or oral breath sample enters the sensing cannula 220, via nostril tubes 196a,b and oral tube 197, and pass into central sample plenum 205. In the particular embodiment example shown in FIGS. 18A, B, and C, the mixing of nasal and oral breath is accelerated by a plurality of optional mixing impellers or vanes 221, so as to assure a uniform sample prior to sensor contact.

The mixed breath sample then flows through exhaust tube 222 opening in the side of plenum 205, the exhaust tube being configured to direct the sample to flow over and around sensor pod 223 which is mounted, for example, in the centerline of exhaust tube 222. The sensor pod 223 includes one or more sensors 224 for an analyte of interest, such as CO₂.

In the example shown, the sensor 224 is generally similar to that shown in FIG. 9, which see. The sensor 224 may include an integral layers including absorbents, filters, semi-permeable membranes, and the like, to precondition the breath sample prior to sensor contact. The sensor 224 responds to the analyte by producing a sensor signal, which is transmitted to a processor unit (not shown) via signal cable 203. Following sensor contact the breath sample exits tube 222 into the ambient air. Note that the lower portion of plenum 205 functions as a condensation trap venting through drain 225.

### SLEEP APNEA ANALYZER, EXAMPLE C

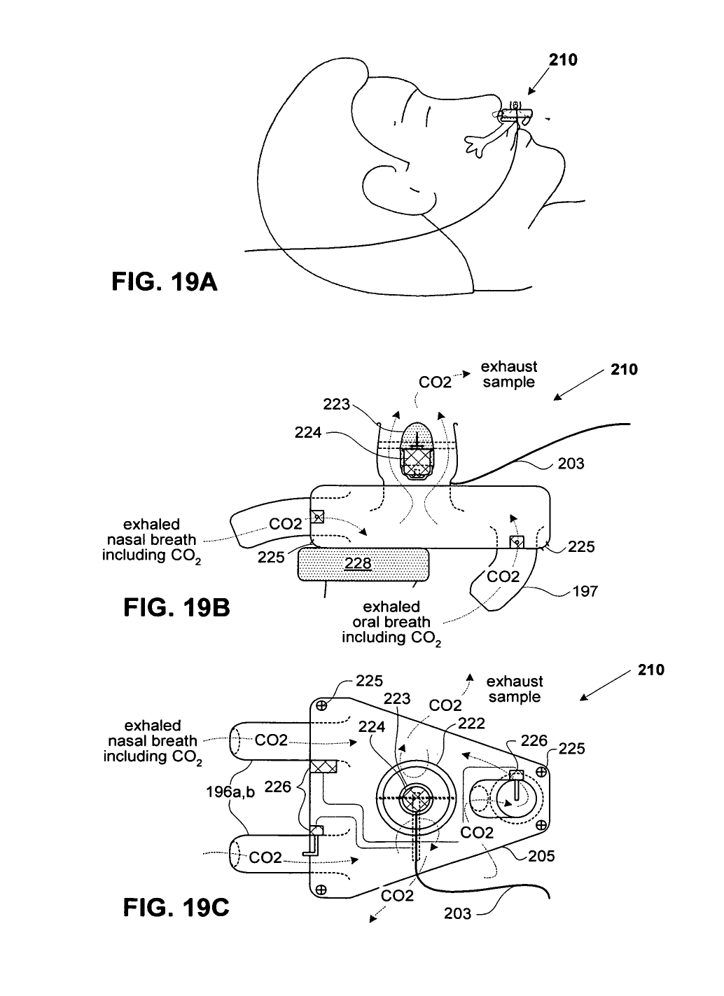

Note that the use of medical gas detecting cannula embodiments is not limited to embodiments configured for supplemental oxygen or other treatment agents. An alternative embodiment shown in FIGS. 19 A, B, and C is configured for convenient use by a sleeping or bed resting patient, so as to detect and monitor one or more medical analytes in the exhaled breath (e.g., CO₂, NO and the like), for example in the monitoring of sleep disorders or airway inflammation.

FIGS. 19 A, B, and C show an exemplary embodiment of an integrated sensing cannula 230 configured to produce signals for input to a processor unit (not shown) particularly adapted to analyze a patients breathing function to diagnose and monitor sleep disorders, such as sleep apnea and the like. Measurements of breath analytes (such as carbon dioxide), blood chemistry (such as oximetry), and the like have been employed in the diagnosis and monitoring of sleep disorders. See for example U.S. Pat. No. 5,605 151, entitled “Method for the diagnosis of sleep apnea”; U.S. Pat. No. 5,891,023, entitled “Apparatus for the diagnosis of sleep apnea”; U.S. Pat. No. 5,954,050, entitled “System for monitoring and treating sleep disorders using a transtracheal catheter”; US Published Application 2005-0113,709, entitled “Diagnostic system and methods for detecting disorders in the respiratory control chemoreceptors”, and International Application WO04-032,719, entitled “Method and apparatus for maintaining and monitoring sleep quality during therapeutic treatments”; each of which is incorporated by reference.

FIG. 19A illustrates the cannula 220 worn by a patient, FIGS. 19B and 19C are a cross section and top view of the cannula 220 respectively. Note that the figures includes both surface and internal elements, diagramed to clarify functional relationships rather than show realistic physical appearance. For clarity and convenience, where elements in FIG. 19 serve a similar function as those shown in FIGS. 14 through 18, the same reference numbers are used, and the description of FIGS. 14 and 18 is to be noted.

During patient use, the mode of operation of cannula 230 is generally similar the cannula 200 shown in FIGS. 16 and 17. Nasal and/or oral breath sample enters the sensing cannula 230, via nostril tubes 196a,b and oral tube 197, and pass into central sample plenum 205. The mixed breath sample then flows through exhaust tube 222 opening in the side of plenum 205, the exhaust tube being configured to direct the sample to flow over and around sensor pod 223 which is mounted, for example, in the centerline of exhaust tube 222. The sensor pod 223 includes one or more sensors 224 for one or more analytes of interest, such as CO₂, NO, and the like. In the example shown, the sensor 224 is generally similar to that shown in FIG. 9, which see. The sensor 224 may include an integral layers including absorbents, filters, semi-permeable membranes, and the like, to precondition the breath sample prior to sensor contact. The sensor 224 responds to the analyte by producing a sensor signal, which is transmitted to a processor unit (not shown) via signal cable 203. Following sensor contact the breath sample exits tube 222 into the ambient air. In the particular example shown, plenum 205 has a plurality of optional drain ports 225, for example at each corner.

In the exemplary embodiment shown in FIG. 19, the cannula includes one or more optional air velocity or flow measuring devices 226. In this example a separate MEMS flow or velocity sensor is mounted to each of sample collection tubes 196a, 196b, and 197, permitting monitoring of breath rate, duration, and distribution between nostrils and oral exhalation. Suitable conductors carry signals from each such flow sensor to cable 203 for transmission to a processing unit (not shown).

A number of alternative MEMS flow sensors or pressure sensors are known in the art, which can be configured to be very compact and consume very little power. For example, a MEMS pressure sensor may comprise a minute reference volume bounded by a conductive membrane, the membrane forming one counter electrode adjacent a second electrode of a microcapacitor. Deformation of the membrane in response to changes in ambient pressure causes a change in the dimensions of the capacitor and a consequent change in capacitance and/or impedance (where d is the electrode spacing, C=εA/d). A pressure sensor can in turn be used to determine flow velocity and flow rate in a tube, for example by measuring dynamic total pressure relative to ambient static pressure.

Alternatively, flow rate may be determined by MEMS devices measuring viscous surface shear, thermal loss rates, and the like. See for example, U.S. Pat. No 6,502,459 entitled “Microsensor for measuring velocity and angular direction of an incoming air stream”, which is incorporated by reference; and the D6F-W01A1 and D6F-W04A1 sensors by Omron Advanced Systems, Inc., Santa Clara, Calif.; and the like.

Typically, cannula 230 is not integrated with oxygen delivery, although it may optionally be integrated with treatment systems. Although the cannula may be aligned and supported in the manner known for oxygen cannulas, such as ear straps, “eyeglasses”, headbands, and the like, the small size and weight of the cannula 230 together with signal cable 203 lend it to simple and comfortable support by skin adhesives in the manner of a adhesive bandage. Cannula 230 may include one or more adhesive anchor bandages 227 and resilient pad 228 to provide a comfortable mounting of cannula 230.

The data signals from the one or more sensors 224, and/or from the one or more optional flow rate or velocity sensors 226 may be recorded, processed and/or analyzed by a processor unit (not shown) for the diagnosis, monitoring and treatment of sleep disorders, by methodology known in the art. A processor unit may be configured substantially as those shown in FIGS. 14 and 16, and may include suitable microprocessors and software for this purpose.

It should be noted that the cannula as shown in FIG. 19 may alternatively be configured for wireless operation, for example, the cannula including a miniaturized transmitter or transceiver unit light enough to be worn comfortably by a patient. A corresponding base unit receiver or transceiver may be placed nearby, to receive and preferably record sensor signals from the cannula. See for example, the capnography adapter shown in FIG. 10B. Additional description of wireless nanosensor systems may be found in U.S. application Ser. No. 11/111,121 filed Apr. 20, 2005 entitled “Remotely communicating, battery-powered nanostructure sensor devices” (published US 2006-0055,392), which application is incorporated by reference.

Having thus described a preferred embodiment of the nanoelectronic capnometer sensor, it should be apparent to those skilled in the art that certain advantages of the within system have been achieved. It should also be appreciated that various modifications, adaptations, and alternative embodiments thereof may be made within the scope and spirit of the present invention. A wide variety of support structure and/or adaptor geometries may be suitable, and the invention is not limited to the particular shapes depicted in the schematic diagrams.

1. A nanostructure sensor for sensing carbon dioxide, comprising:
a substrate;
a first nanostructure disposed adjacent the substrate;
one or more conducting elements in electrical communication with the first nanostructure; and
at least one recognition material operatively associated with the first nanostructure, the at least one recognition material configured for interacting with carbon dioxide.

2. A nanostructure sensor as in claim 1, wherein the recognition material is in direct contact with the nanostructure.

3. A nanostructure sensor as in claim 1, wherein the recognition material is in isolated from the nanostructure by a dielectric layer.

4. A nanostructure sensor as in claim 3, wherein the dielectric layer is less than about 500 nm thick.

5. A nanostructure sensor as in claim 4, wherein the dielectric layer is between about 50 nm and 1 nm.

6. A nanostructure sensor as in claim 5, wherein the dielectric layer is between about 30 nm and 5 nm.

7. A nanostructure sensor as in claim 3, wherein the dielectric layer is deposited by atomic layer deposition (ALD).

8. A nanostructure sensor as in claim 7, further including at least a second layer deposited by ALD having material properties distinct from the dielectric layer.

9. A nanostructure sensor as in claim 8, wherein the second layer includes a recognition material configured for interacting with carbon dioxide.

10. A nanostructure sensor as in claim 1, wherein the recognition material further comprises an aqueous solution capable of reacting with carbon dioxide.

11. A nanostructure sensor as in claim 10, wherein the recognition material comprises an accelerator configured to catalyze the conversion of aqueous carbon dioxide to carbonic acid.

12. A nanostructure sensor as in claim 11, wherein the accelerator comprises carbonic anhydrase.

13. A breath analyzer system comprising:
a breath sampling cannula including one or more lumens configured to by mounted adjacent at least one of a patient's nostril and mouth, the lumen having an opening arranged to gather an exhaled breath sample upon patient exhalation;
one or more nanostructure sensor comprised as in claim 1, the sensor in communication with the lumen of the breath sampling cannula, so as to contact at least a portion of the exhaled breath sample; the sensor have a sensitivity carbon dioxide (CO₂) in human exhaled breath so at to produce a sensor signal in response to the breath species;
a processing unit in communication with the sensor so as to receive the sensor signal, the processor unit configured to use the signal to determine a measurement of one of:
(i) the concentration of CO2 in the sample; and
(ii) the amount of CO2 in the sample, and
an output device in communication with the processing unit and configured to output at least the measurement to a user, so as to provide information related to a human medical state.

14. A breath analyzer comprising:
one or more first sensors comprised as in claim 1 having a sensitivity for carbon dioxide;
at least one second sensor having a sensitivity for at least one second non-carbon-dioxide species found in human exhaled breath, and wherein the concentration of carbon dioxide and the second species in human exhaled breath has a correlation with a human medical state;
a breath sampler configured to sample at least the exhaled breath of a patient, and in communication with the first and second sensors;
a prcoessor system in communication with the first and second sensors and configured to measure the concentration of carbon dioxide and the second species, and to the measurements to a user, so as to provide information related to the human medical state.
